(19) United States
(12) Patent Application Publication
(10) Pub. No.: US 2005/0144218 A1
(43) Pub. Date: Jun. 30, 2005

(54) Extendible software platform for the construction and deployment of intelligent agents

(76) Inventor: Timothy James Heintz, Richardson, TX (US)

Correspondence Address: TIMOTHY J. HEINTZ, 806 MT. VERNON DR., RICHARDSON, TX, 75081, US

(21) Appl. No.: 10/724,589

(22) Filed: Nov. 25, 2003

(51) Int. Cl. G06F 15/16

(52) U.S. Cl. 709/202

(57) ABSTRACT

A system and methods for building and executing intelligent agents are disclosed. This system allows the automatic invocation of computerized software services using Boolean conditions to determine if and when a specific service or task is executed. Intelligent agents within the platform can communicate with each other through a message-handling infrastructure. The message-handing system includes methods for data encoding/decoding, encryption and transport across multiple protocols. This system also includes methods for event handling, task selection, agent mobility, and agent persistence. A graphical user interface helps individuals define and monitor agent activity. This system is highly extendible, providing methods for the addition or inclusion of alternative agent services, message-handling approaches, event-handling systems and task-handling approaches.

### REFERENCE TO RELATED APPLICATIONS

This application claims the benefit of U.S. provisional application No. 60/426,767.

### FIELD OF THE INVENTION

The present invention generally relates to the field of computerized intelligent agents, and more particularly to the development and use of a highly robust, standards-based and extensible software system for the construction and deployment of intelligent agents. We call this software system an “Agent Platform” or simply platform.

### BACKGROUND OF THE INVENTION

Prior patent art and publicly available research documents present a number of methods and systems for supporting the development and use of intelligent agents. This is an evolving technology area in which routine decision making tasks can be delegated to software modules call “agents” that can act on behalf of an individual or group of individuals.

As more people use the computer for on-line transactions and as more computerized services become available to the user, it becomes increasing difficult for an individual to process and manage all the information and activities that computer services can potentially handle. The methods and systems provided by this invention will enable users to delegate information processing tasks to a set of intelligent agents that can access data, analyze and filter the same, and execute actions based upon this information.

One key aspect of using intelligent agents is the ability of agents to automatically perform tasks on behalf of the user of the system. One way for agents to perform action is to execute software services. Software services can also generate data that agents might use. This invention-provides methods and systems for configuring and managing these services and for enabling agent-based access to these services.

There are specifications for a number of semantically-based agent communications methods such as Abstract Content Language (ACL), Knowledge Interchange Format (KIF), and Knowledge Query and Manipulation Language (KQML). This invention provides a method and system to support multiple agent languages through the addition of content handlers and that perform incoming message translation and interpretation and message builders that format outgoing messages according to specific semantic rules.

There also exist standard protocols for software communications over networks. These include RMI, COBRA, XML/SOAP, JINI, JXTA and others. In addition, specific industries have developed their own proprietary EDI protocols. This invention provides a method and system for adding new communications protocols and data encoding schemes so the agents can operate over a number of heterogeneous network systems.

There have been inventions involving systems and methods to develop rule-based inference engines and expert systems. These include stand-alone expert systems shells and business rule engines with application program interfaces to maintain and interpret rules. This invention provides method for integration of these rule-based concepts to provide a system for determining if, when and where agent tasks are performed. Using a method similar to that discussed earlier for specifying services and communications handlers, this invention provides a method and system for specifying alternative rule interpretation or inference schemes and associates one of them with a specific agent.

There exists a technique for having rules interpret data called the Rete algorithm. This invention provides a method and system for having the agent consider appropriate rules (or have the rule “triggered”) as data is presented to the system by using the type of data patterns defined within the Rete algorithm. The method included in this system extends the state of the art by providing a technique in which individual insertions of data can immediately trigger a rule. In a similar manner, the addition of a rule may result in the immediate consideration of whatever data that may be associated with it.

There exist methods for creating and reporting events that may occur with a computerized system. These include publish/subscribe technologies, such as provided by in various systems including JavaSpaces and Java Messaging Services (JMS). Our invention includes a method and system for the integration of such technologies for the specific purpose of triggering the consideration of an agent's rule.

The current state of art includes systems and methods supporting the construction of agents that handle specific tasks or applications. This invention introduces a method of using templates to create and deploy multiple types of agents. To assist in constructing templates, the system provides a user interface that supports construction of any type of agent template and a method for using this template to deploy an agent to the agent platform. Our invention also includes a computer language as an alternative method for specifying agent templates.

The current state of art for systems and methods supporting the construction of agents specify agent construction tool kits that provide software for assisting developers in writing agent-based software applications. None provide the comprehensive, highly integrated, and extendible software system that comprises this invention. This invention provides a system for combining the tasks of construction, deployment, execution and management of agents and the computer services used by agents.

Therefore, there is no existing system or method that integrates the variety of software services that an agent may execute or general methods for specifying and deploying agents in the comprehensive manner of this invention. As a result, the state of art limits the construction and deployment of software agents to specific application areas or to generic systems that provide limited flexibility and extensibility.

Currently, there are many computing service providers that allow users to set up software agents at their own locations. This requires the user of the agent-based services to specify separate agents that perform the same basic activity at each of these locations. This invention is unique in that it provides a common platform supporting a plurality of communications protocols. This allows the user to setup a single agent at his “home” location that may interact with multiple service providers. It is the invention's ability to support alternative communications protocols that facilitates the interfacing of this single agent or set of agents with many potential providers of software services. For example, in one embodiment of this invention an individual wishing to access job placement services can setup a specific agent to access multiple placement services. The current state of art requires the user to specify separate agents at each location.

This invention heavily relies on Object-Oriented design and programming principles. Thus in describing this invention, this document references groupings of program code or software modules called objects. In describing methods comprising this invention, this document references procedures included within a sequence or one or more objects. Methods described will include both processes initiated by a person using this invention and those initiated automatically by the objects comprising the system.

### SUMMARY OF THE INVENTION

It is the object of the present invention to provide a general software system, called an agent platform or platform that enables automatic access to a variety of software services though the creation and use of software objects called intelligent agents.

It is the further object of the present invention to provide a system and method for managing the creation and removal of agents. This management system includes the capability to move agents in and out of persistent data storage and to move agents from one platform to another.

It is the further object of the present invention to enable the inclusion of a plurality of information processing services to be determined in number and content by configuration data.

It is the further object of the present invention to enable the intelligent agents, to interact with these software services.

It is the further object of the present invention to provide an event handling mechanism that enables agents to react to changes to data within its local environment. The data in the local environment may include both information accessible only to the agent or information shared by two or more agents. This invention includes methods to enable the configuration of the system to optionally enable agents to use external event handling systems as an option for reacting to events generated within shared information spaces.

It is the further object of the present invention to enable intelligent agents to interact with each other through a messaging system. This invention comprises methods for configuring the message system and supports specification of a plurality of message transport systems, encryption techniques, data formats, and information content structures.

It is the further object of the present invention to use Boolean conditions, included in objects called rules, to control if and when services the platform executes services in reaction to events ocurring within the environment. This invention provides methods for specifying these rules.

It is the further object of the present invention to have system for supporting a plurality of methods for interpreting and managing rules. This invention provides methods for configuration and selection of these rule-handling systems called inference engines or interpreters.

It is the further object of the present invention to enable intelligent agents to invoke the services available to the platform and to insure that a method exists for informing the agent of any data generated by services.

It is the further object of the present invention to include a preferred embodiment of an inference engine that reacts in real-time to data patterns presented to the agent.

It is the further object of the present invention to enable users of the system to easily specify behaviors of the system. This invention provides a methods and systems to accomplish this task by creating objects, called agent templates that describe the agent's rules and data. Such methods involve using a graphical user interface for specifying agent templates, deploying agents and monitoring system activity. This user interface is intuitive and very easy to use.

It is the further object of the present invention to provide a computer language as an alternative method for specifying agent templates.

It is the further object of the present invention to provide a graphical user interface for monitoring activities occurring within the systems. This monitoring system uses the event mechanism used by agents to track context changes as well as internally generated events for notify users of incoming and outgoing messages and service executions.

It is the further object of the present invention to provide systems to handle specific tasks needed to support agent activities including (1) serializing agents and agent messaging into byte streams, (2) managing the specification of data values of varying types used by agents and (3) representing the rules and tasks (services) executed by the rules, and (4) insuring the protection of any all data maintained by the platform from system failures.

It is a further object of this invention to compile to industry standards for agent implementations as applicable. This invention follows specifications established by the Java Agent Services (JAS) and the Foundation for Intelligent Physical Agents (FIPA) in defining the interfaces to the services. The innovation associated with the present invention is the method of implementation and not in the definitions of these services.

The present invention comprises a system, which includes components for (1) interfacing with both local and remote software services, (2) generating, sending, receiving and interpreting messages transferred between agents, (3) generating and receiving events concerning changes in data and platform activities, (4) reacting to these events by conditionally invoking services, (5) managing the life cycle of these agents, and (6) having the person using the system interact with the system.

The present invention comprises methods for (1) adding and removing services including communications services, (2) constructing and deploying agents, (3) adding and removing alternative message formats, protocols, encryption methods, and authentication approaches, (4) adding and removing agent context data from the system, (5) accessing external event handling systems for enabling shared access to data, (6) specifying the use of alternative methods for selecting and invoking services in response to events, and (7) specifying and using the rules use by agents to determine when to invoke services.

Some important aspects of this system are its ability to inter-operate with a variety of external software services and systems, to adapt itself to differing computing environments and to scale well as the number of agents and service executions increase.

Another important aspect of this system is its ability to allow computer systems developers to extend the platform by adding computer code or new software components. To accomplish this task this invention specifies both a methods for configuring and adding these components and application programmer interfaces to which extension developers must comply. An application programmer interface is a set software program calls that must be implemented within the code added to the platform. Application programming interfaces exists for defining modules that allow agents to interact with services and add messaging components for message transport, data encoding and decoding, content handling and building, encryption, authentication. This system includes interfaces for defining event handles and creating inference engine components.

Another important aspect of this system is its ability to operate within a variety of applications areas. This invention in varying embodiments can support a large number of business and engineering tasks. These include but are not limited to making online payments, monitoring movement of materials, scheduling and dispatching service personnel, securing facilities, allocation of resources in computer, power and transportation networks, diagnosing potential equipment problems or failures, and controlling the temperature and lighting with a home or building.

The present invention in varying embodiments is also useful in consumer applications that include but are not limited to paying bills, locating product on-line to purchase, managing investments, searching for employment, controlling home appliances such as security systems and audio-visual equipment, investment management and computer game playing. In general any situation, which allows access and control by means of a computer, presents a potential for application of the present invention.

Additional objects, novel features and advantages of the invention will be set forth in part in the description which follows, and in part will become more apparent to those skilled in the art upon examination of the following or may be learned by practice of the invention.

### BRIEF DESCRIPTION OF THE DRAWINGS

FIG. 1 shows an overview the key components or subsystems of the system.

FIG. 2 shows major components associated with managing the life cycle of an agent.

FIG. 3 is a flow chart describing a method for creating new agents.

FIG. 4 is a flow chart describing a method for activating existing agents.

FIG. 5 is a flow chart describing a method for deactivating agents.

FIG. 6 shows major components associated with managing services.

FIG. 7 is a flow chart describing a method for installing configured services upon startup.

FIG. 8 is a flow chart describing a method for having agents select and execute services.

FIG. 9 shows major components associated with the message handling system.

FIG. 10 is a flow chart describing methods for registering interest and report of agent context events.

FIG. 11 shows major components message handling system.

FIG. 12 is a flow chart describing method of receiving agent messages.

FIG. 13 is a flow chart describing a method of sending agent messages.

FIG. 14 is a flow chart describing a method of receiving agent messages.

FIG. 15 shows the major components of the Inference and Task Execution system.

FIG. 16 is a flow chart describing a method of executing agent tasks.

FIG. 17 shows the functionality of the pattern matcher inference engine.

FIG. 18 is a flow chart describing a method for activating the rules associated with the pattern matcher inference engine.

FIG. 19 is a flow chart describing a method for asserting facts into the pattern matcher inference engine.

FIG. 20 shows an initial display for one embodiment of a user interface for this invention.

FIG. 21 shows a display for a configuration data editor.

FIG. 22 shows the initial view for the user interface for an agent Template Editor.

FIG. 23 shows the initial view for the user interface for an agent Template Editor that allows entry of attribute values.

FIG. 24 shows a dialog window for entering new fact values.

FIG. 25 shows the initial view for the user interface for an agent Template Editor that allows entry of rules.

FIG. 26 shows a dialog window for editing relations.

FIG. 27 shows a dialog window for creating and editing predicate data.

FIG. 28 shows a dialog window for editing agent task data.

FIG. 29 shows a dialog for deploying agents from templates.

FIG. 29 shows a window for monitoring platform activities.

### DETAILED DESCRIPTION

The present invention relates to automating routine decision making tasks. In the preferred embodiment of the present invention, an agent platform is configured to (1) access a set of predefined software services, (2) support a set of messaging protocols and formats, (3) optionally provide support for one or more message encryption schemes, (5) setup up one or more event contexts to which agents may subscribe an interest, (6) use a rule-based inference techniques for use in determining when and if services are executed, and (7) load a set of active agents into it processing memory.

An Agent in this invention represents a software module that is deployable within the platform and has access to the platform's service, event and communications systems and methods.

Furthermore, an intelligent agent contains an interpreter or inference engine, which includes a set of one or more rules and an algorithm for the handling and evaluation of these rules.

Rules comprise (1) triggers which are objects use to determine when a inference engine considers a rule, (2) a set of one or more task objects, which reference platform services, and (3) a optional logical “precondition,” which the inference engine can use to determine whether or not to execute a triggered rule's set of tasks.

A computer memory area called the agent context provides references to values used by the agent. This invention includes set of predefined data structures or values types. Furthermore, it allows the specification of alternative data structures for use within an agent context, typically associated with a specific inference engine.

An event-mechanism that automatically provides notification to agents concerning changes within their context.

Once a rule is considered, the inference engine will evaluate the rule's precondition. If it does not exist or if the rule's precondition evaluates to true the agent's will execute its set of one or more tasks.

Task execution causes service executions to occur, which depending upon the executed service, may result in changes to the agent context.

Incoming messages may also result in changes to an agent's context.

Changes in the context values can then result in the triggering of additional rules.

The present invention comprises methods for rules to registrar an interest in triggering events, insuring the notification of the rules as data changes.

In one embodiment of the inference engine called a pattern matcher, the system extends agent context to represent data structures called “tuples.” A tuple represents a named group of related data items. The pattern matcher inference engine then uses patterns in incoming sets of tuples to trigger the rule and provide data for precondition evaluation and task execution.

The present invention comprises methods creating and destroying agents and for moving the agent into active or inactive state. If an agent moves into an inactive state, it will remove its subscription in events associated with each of the agent's rules. Thus inactive agents will no longer respond to changes in context data. When an inactive agent becomes active its will re-subscribe itself to the events associated with the agent's rules.

Within the present invention methods exists for persisting agents on computer mass storage devices and for moving an agent from one agent platform to another. Upon receipt of a request to move or store, an agent is encoded into a byte stream and placed within a message structure, which is sent to a destination platform. Upon arrival or retrieval of an agent, methods exist to decode the byte stream into software object represent the agent, which then is activated and placed in the platform's memory. This invention supports a plurality of encoding and decoding schemes, as presented in the subsequent discussion on message handling.

Within the present invention, an agent may use any one of a number of configured transport services to receive messages directed to it and send messages to other agents. The transport services include support for a plurality of standard and proprietary transport protocols. Some standard protocols include but not limited to Transport Control Protocol (TCP), Standard Network Mail Protocol (SNMP), and some Peer-to-Peer protocols such as JXTA and JINI. The present invention provides a common programming interface usable for the development and inclusion of new transport systems.

Within the present invention, the system may optionally encrypt and decrypt for security reasons. The present invention supports use of a plurality of standard encryption and decryption schemes. These schemes may include authentication of agents to insure that they are authorized to send messages. The present invention can support both password and certificate-based authentication schemes.

Within the present invention, the messages may be encoded in one of a number of standards and/or proprietary data formats. Some data formats include, but are not limited to, those defined by the Extendible Markup Language (XML) and Multipurpose Internet Mail Extensions (MIME) specification. The present invention allows inclusion of a plurality of encoders that have a responsibility of taking platform objects and translating then into a specific data formats (a serialized form) and decoders that construct objects from various serialized forms. This invention includes methods to configure the set of encoders/decoders available to the platform. The present invention provides a common programming interface and method usable for the development and installation of new encoders and decoders.

Within the present invention, messages are structured using a specific content language. The content language may include commands requesting specific actions and named data values. There are content languages suggested by the current research efforts in the area of intelligent agents that include Abstract Content Language (ACL), Knowledge Exchange Format (KIF), and Knowledge Query and Manipulation Language (KQML). The present invention specifies a simplified message structure, but also allows for the addition of other content languages, such as but not limited to the above. The present invention comprises of method to install these alternative content languages through the addition of Message Handling objects that interpret incoming messages and updates an agent's private context and Message Generator objects that can take data from the agent's context and convert it into the appropriate message structure. Message Handlers/Generators may optionally use a structured dictionary or ontology for translating or interpreting data within the message.

This present invention provides systems and methods for configuring, monitoring, constructing and modifying the agents and agent platform through a graphical user interface (GUI). The present invention uses an internal event mechanism to report primarily on message receipt and transmission, agent context changes, service execution and any reported error conditions. The GUI registers an interest in certain events and can post events on the users interface devices (such as a CRT monitor). The user can also use the GUI to initiate changes in agent tasks, rules and context values.

The present invention also uses the same event system to record platform activities to one or more log files depending upon the event.

To insure system reliability, the present invention will, upon shutdown, save all the cached agents and any configuration information modified during the execution of the platform. Furthermore, there is a method to optionally checkpoint the state of the system and all agents at periodic intervals. The saved information at checkpoint time includes messages that may be queued up by individual transport services. In event of crash, the system may then be able to recover from the last check-pointed state.

The figures within document describe the details of most of the above systems and methods.

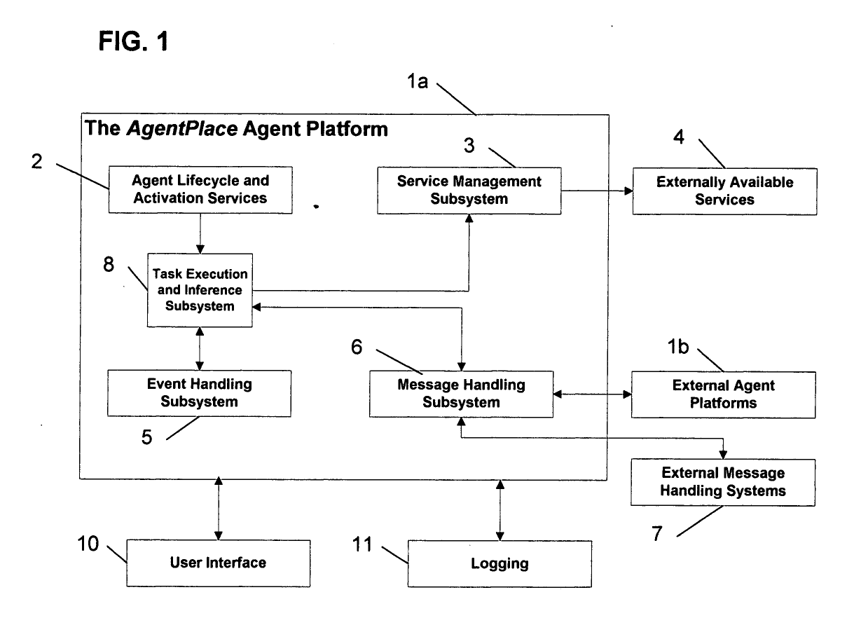

FIG. 1 summarizes the major functionality described above by describing components of a single platform 1a containing agents that may interact with other agents located both internally or in external platforms 1b.

The Agent Life Cycle and Activation Services 2 is responsible for construction, destruction, movement, activation and deactivation of agents.

Services that agents use are managed within the Service Management Subsystem 3, which will allow access to both internally constructed services as will as external services 4.

The Message Handling Subsystem 6 processes both incoming and outgoing messages. Messages may occur among agent within the platform, but also can occur between platform agents and agents that resides in external platforms 1b. It is also possible to receive and send messages that are transmitted between an agent and some external messaging system 7 not associated with an agent.

The Event Handling Subsystem 5 will provide notification of changes to agent context data. The Task Execution and Inference System 8 determines when and if services are executed.

The Task Execution and Inference subsystem 8 determines when and if agent tasks are executed by the system.

Each component of this platform can generate internally produced events. This is separate from the Event Handling subsystem, which only reports agent context data changes. The object of internally generated events is to report to both Logging 10 and User Interface 11 subsystems. These components register an interest in those internal events that they wish to report. Through this method, the present invention can support plurality of User Interfaces and log repositories.

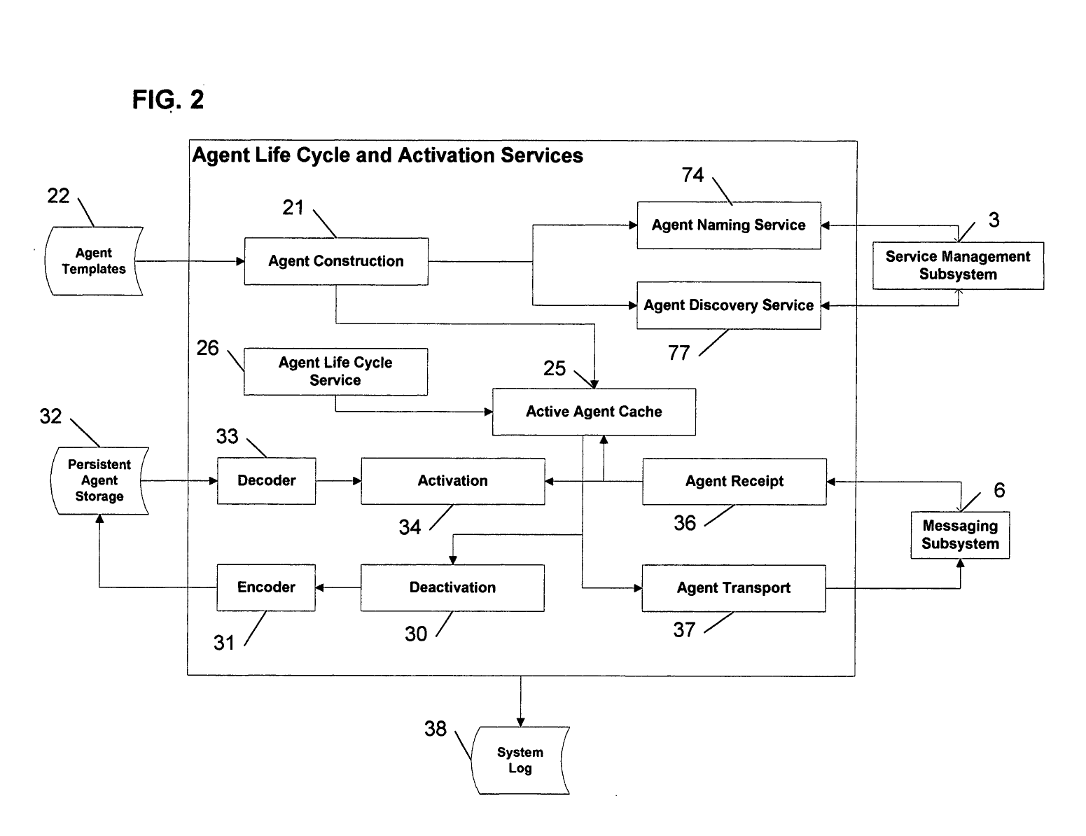

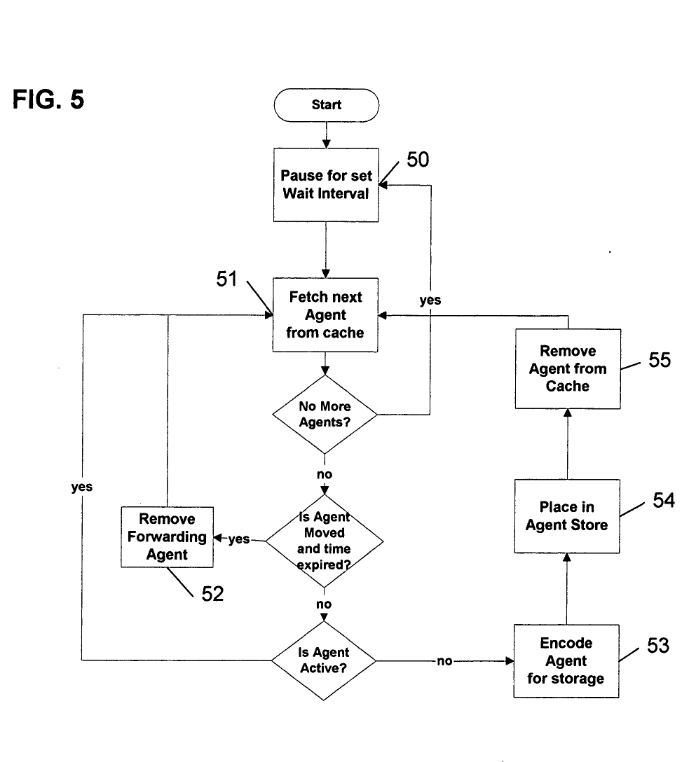

FIG. 2 presents components of the Agent Life Cycle and Activation Services. This includes the ability to construct new agents 21 by optionally using a previously stored template 22. This system then places that agent in the agent cache 25. The deactivation process 30 allows for persistent storage 32 of agents if they are inactive for a specific time period. An encoder 31 coverts the agent to a serialized stream of bytes for storage. The activation process 34 retrieves agents from the persistent store requiring a decoder 33 to convert from the serialized form into objects. During agent construction an Agent Naming Service 74 (also see FIG. 5) provides globally unique identifiers for the agent. The agent is also registered with an Agent Discovery Service 77 (also see FIG. 5) so that other agents can locate it. The Services Management Subsystem (see 3 FIG. 1) provides a means to access both of these services.

The Messaging Subsystem 6 (see FIG. 1) handles process of moving agents from one platform to another. This includes the transport 37 and receipt 36 of agents encoded into agent messages. Since this involves both messaging and life cycle concepts, the details associated with agent mobility is deferred to the discussion on agent messaging.

The internal Agent Life Cycle Service 26 enables the agents and other platform objects to initiate requests to create, activate, deactivate, remove and move agents.

FIG. 2 illustrates the method for creating new agents. This method uses an agent template 40 to create agents. Within our invention a template is an object containing information describing how to construct an agent. Agents comprise a many components including an inference engine, which in turn comprise value and rule objects (and rule objects comprise trigger, precondition and task objects). The template thus parallels this agent structure by containing descriptor objects for each component, which may themselves contain other descriptor objects. Each type of object contained within an agent has a differing type of descriptor object. Each descriptor object has code within it that knows how to construct the component object that the agent uses. Thus the method of constructing an agent involves this process of a template using contained descriptors to recursively construct the agent and all its components 42. If no template exists then the method constructs an empty agent containing a specified or default inference engine, which itself contains no data or rules.

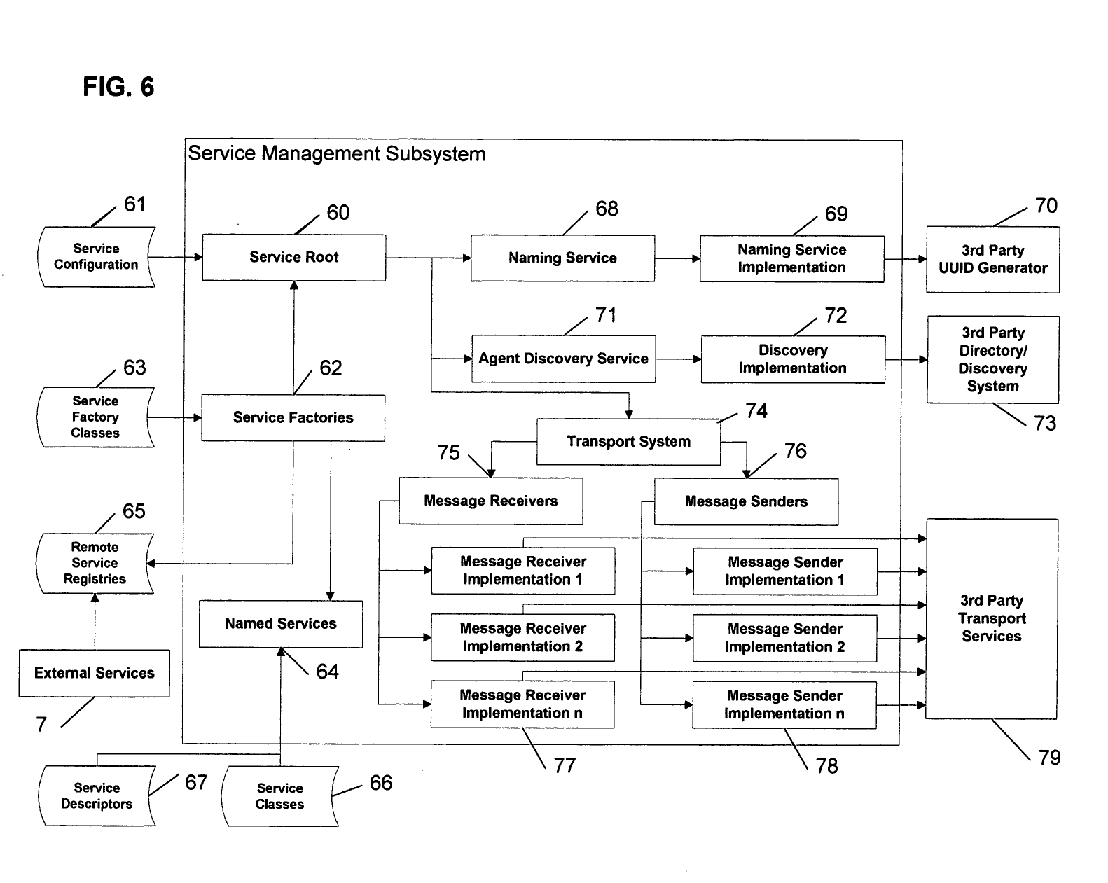

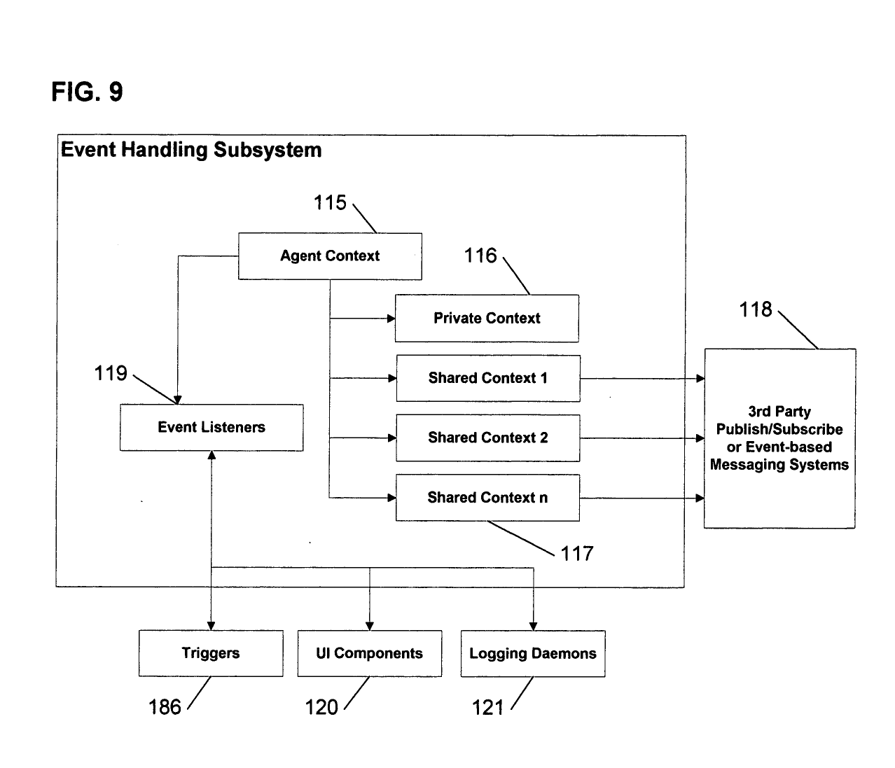

This method also uses an agent naming service 43 (also see 68 in FIG. 6) to uniquely identify the agent and registers the agent in an agent discovery service 44 (also see 71 in FIG. 6). This method also activates 45 the agent by registering the triggers for the agent's rules with the agent context entries monitored by the rules. This process is discussed in more detail later in the discussion on the event handling subsystem (see FIG. 9). Finally, this method adds the new agent to the Agent Cache 46.

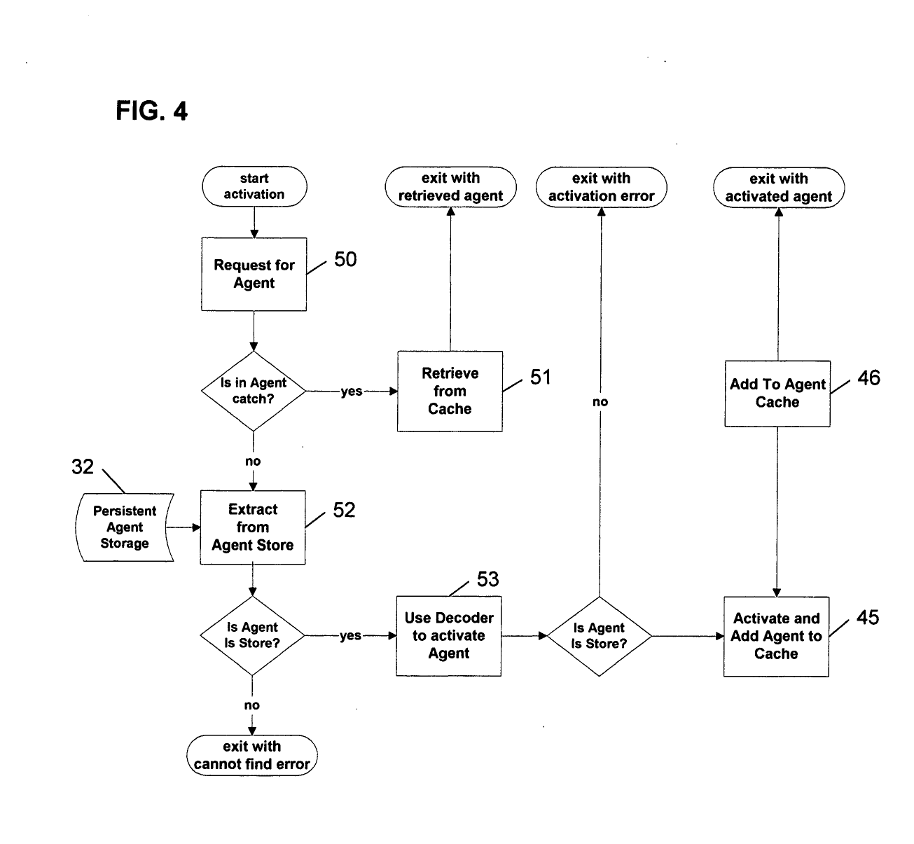

FIG. 4 illustrates the method associated with the agent activation process. This process is initiated by a request for an agent. These requests occur from either Agent Life Cycle Service (see 26 in FIG. 2) requesting a change in agent status, or an incoming message (see 36 in FIG. 2) that references an agent. In all these cases is the Agent Cache (see 25 in FIG. 2) is checked. If the agent is in the cache, then returning a reference to the cached agent satisfies the request 51. If not then a serialized agent is extracted from the persistent store 52. If found the appropriate decoder 43 constructs the agent from its serialized form. If the agent is not within the store, an error exit occurs reporting an agent not found error event.

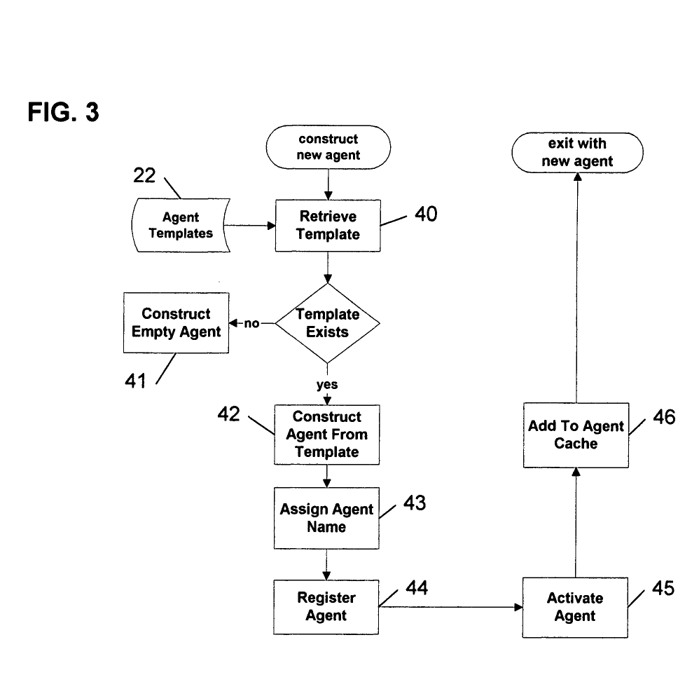

This method then requires registration 44, and as done with newly constructed agents (see FIG. 3), the agent is added the cache.

FIG. 5 illustrates the method associated with the agent deactivation process. Agents are deactivated or moved to persistent storage when either the agent's status is set to inactive by a user or another agent or if an active agent has not had any recent activity to which it had to respond. The present invention includes this method to free up valuable agent cache space. The deactivation process runs continuously within its own execution thread. The process will pause or “sleep” for a configured time interval 50 and then it sequentially fetches agents from the cache 51. After checking all agents during a particular cycle, the thread reenters its sleep state. This method also checks to see if the currently fetched agent a forwarding agent. Forwarding agents are placeholders for agents that moved to another platform and only remain in the system for a short period of time. This agent handles any messages received in the time interval between departure for the current platform and registration of the reactivated agent on the remote platform. The method of FIG. 5 checks to see if the forwarding agent's time limit expired. If so the thread removes the agent 52. Otherwise, this method encodes the agent into a serialized form 53, writes it to the persistent store 54 and removed from the agent cache 55. This process continues until all agents in the cache have been examined.

The method to remove agents requires both deactivating the agent and removing it from the discovery service.

These activation and deactivation methods and the event handling methods discussed later also support the function of enabling the backup and recovery of agents. This platform can routinely save active agents on a persistent store so they can be reactivated from a known state should problems occur within the system. Logging of context change and rule additions and removals also enables the reprocessing of events to bring the agents state foreword to the time of the crash.

FIG. 6 presents components associated with the service management subsystem. The Service Root 60 has primary responsibility for accessing and constructing available services. The service configuration 61 contains names of various service providers, each of which references a special type of object called a Service Factory. The Service Root loads these Service Factories 62, using configuration data that specifies the name of Service Factory object. This factory object name enables the construction of the factory object from the object's code (class definition) 63 stored on the local file system. The Service Factory knows specifically how to construct a named service 64. Alternatively, a service may be a remote service in which case the Service Factory retrieves a proxy for the service from a Remote Service Registry 65 such as the Java RMI Registry. The service proxies provide access to services external to the local platform 7 (see also FIG. 1). Services provided by a Service Factory may also have Service Descriptors 67 that provide descriptive information and configuration parameters for the service.

One included standard services specified in the FIPA specification is a Naming Service 68. The present invention comprises an implementation 69 of this naming service that can incorporate of one of numerous 3rd-party Universally Unique ID (UUID) Generators 70 as the provider of the computational algorithm. This system allows specification the UUID generator as a configurable user configurable parameter. Similarly, this system provides an implementation of the FIPA standard Agent Discovery Service 71. This implementation 72 that can utilize one of a set of 3rd-party discovery or directory systems 73.

Again, following the FIPA specification, this invention includes a Transport System 74 that provides access to a set of Message Receivers 75 and Message Senders 76. The present invention's implementation allows for deployment of a plurality of Message Receiver implementations 77 and Message Sender implementations 78. Each differing receiver/sender combination supports an alternate transport protocol. This implementation allows a specific platform configuration to simultaneously process messages that use different transport protocols. Again, in an effort to gain maximum use of already existing software, some of the transport system implementations may utilize existing 3rd-Party Transport Services 79.

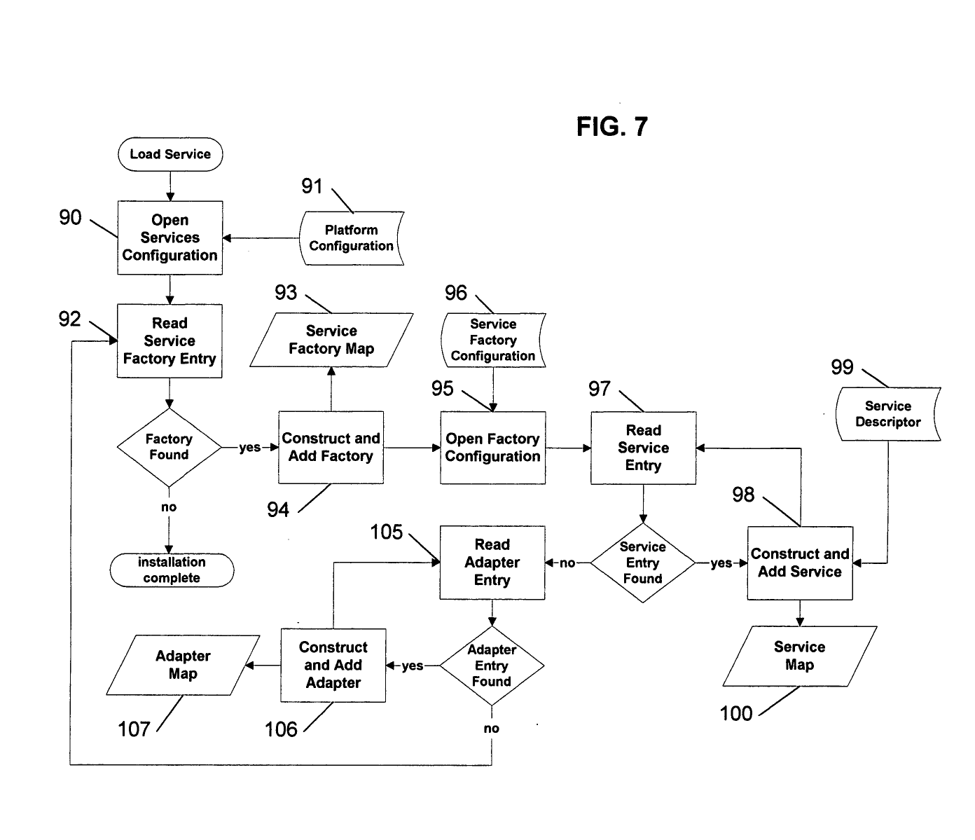

FIG. 7 illustrates the methods for using configuration data to activate services at system startup. Configuration files exists for the platform, for individual service factories and for the services themselves. Appendix A provides more detail on platform configuration. This method begins by reading 90 the platform configuration 91. The configuration file contains a list of service factories supported by the system. This method iterates 92 through each specified service factory. Upon finding a service factory specification, this method uses the configured class name to construct the service factory object from program code stored on the local file system (see 63 in FIG. 6). This method then uses an internal data structure called a map to store the constructed factory instance 93. Maps are table type structures that allow access to objects by an identifying key such as a name.

The platform configuration file also specifies the location of one or more factory configuration files 96 that provide information how to construct the factory and information on any factory supported services that the system user wishes to install upon system startup. In a manner similar to loading factories, this method reads this new configuration file 95, and for each service entry 97, it constructs service objects 98, using service descriptors 99 to optionally configure the service and storing the results in a service map 100. Service entries in the service map may reference to remote services as discussed earlier.

To save computing resources this invention does not require construction all services at startup, but rather allows the system to access the service factory to construct a service when requested. This can save computing resources for seldom-used services. This system also supports the capability to expire (remove from the service map) services that agent have not used for a specified time period.

Agents can execute services though the use of an intermediate object called a service adapter. A service factory can also specify the construction of service adapter objects in an identical manner as services. Each adapter configuration entry will reference an adapter class. This method inputs the class specification 105, constructs the adapter 106, storing it in an adapter map 107.

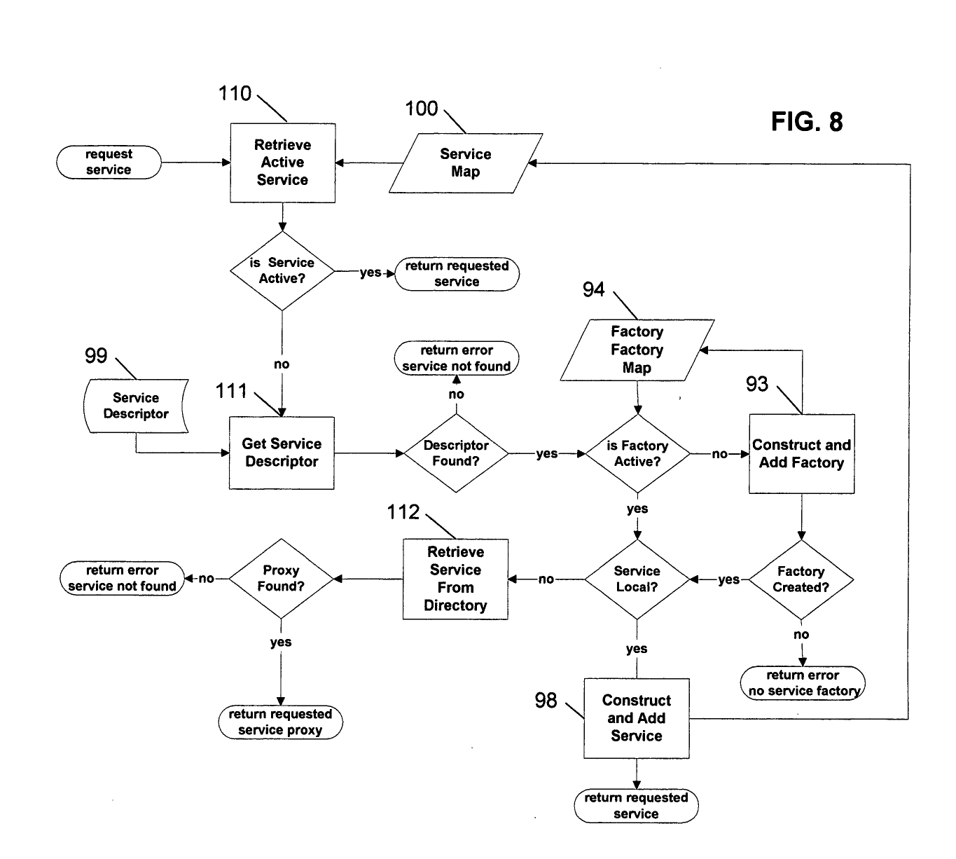

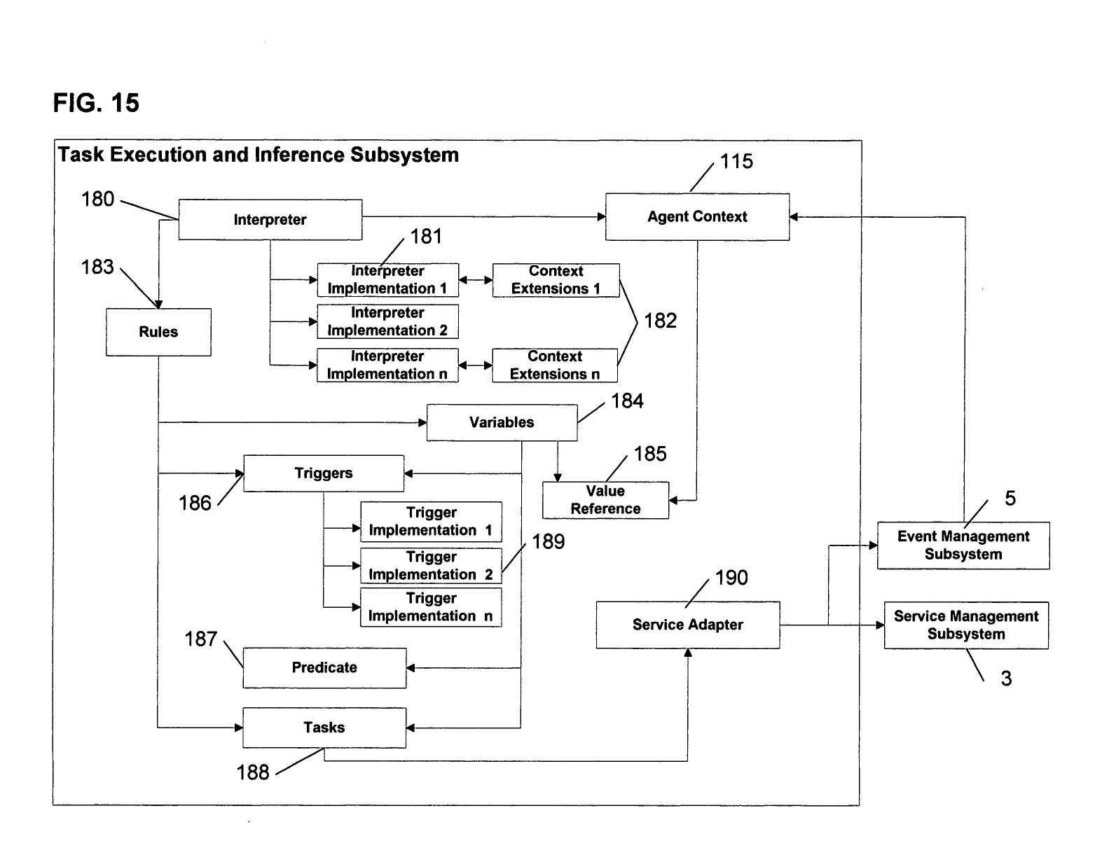

FIG. 8 illustrates the method for accessing services. The execution of an Agent's task (188 in FIG. 15), usually initiates the request for service. When received by the Service Root (60 in FIG. 6), it checks to see if the service is currently active. If it is, this method immediately retrieves that service 100 from the Service Map 100 (see FIG. 7). If not the Service Descriptor is accessed 111. Service provider and service name identify individual Service Descriptors. This process is aborted with an error condition if there is no Service Descriptor. Next step involves checking for the existence of a Service Factory for the service provider name. As with services that are construction at startup by the configuration process (see FIG. 7), the method constructs a factory 92 if not available. If construction of the Service Factory fails the process terminates with an error. This typically would occur if the Service Factory class was not available. Once, located or constructed, the Service Factory then checks to see if requested service is local. If it is a local service is constructed 93 else the Service Factory locates a remote proxy for the service 94. In both cases, the Service Root registers resultant service or proxy so that it is available for the next request.

FIG. 9 presents components associated with the Event Handling subsystem. Events are constructed whenever entries within the Agent Context 115 change. The Agent Context comprises context entries, which are attribute-value pairs stored within either a Private Context 116 for the agent or optionally one or more Shared Contexts 117. Shared contexts may reference values and receive event notifications using 3rd-party public/subscribe or messaging systems 118, such as provided by Java Messaging Services and JavaSpaces. When changes occur to context entries, the events are sent to a set of registered Event Listeners 119. These Event Listeners are typically Triggers 166 for agent rules 188 (see FIG. 15), UI Components 120 or Loggers 121.

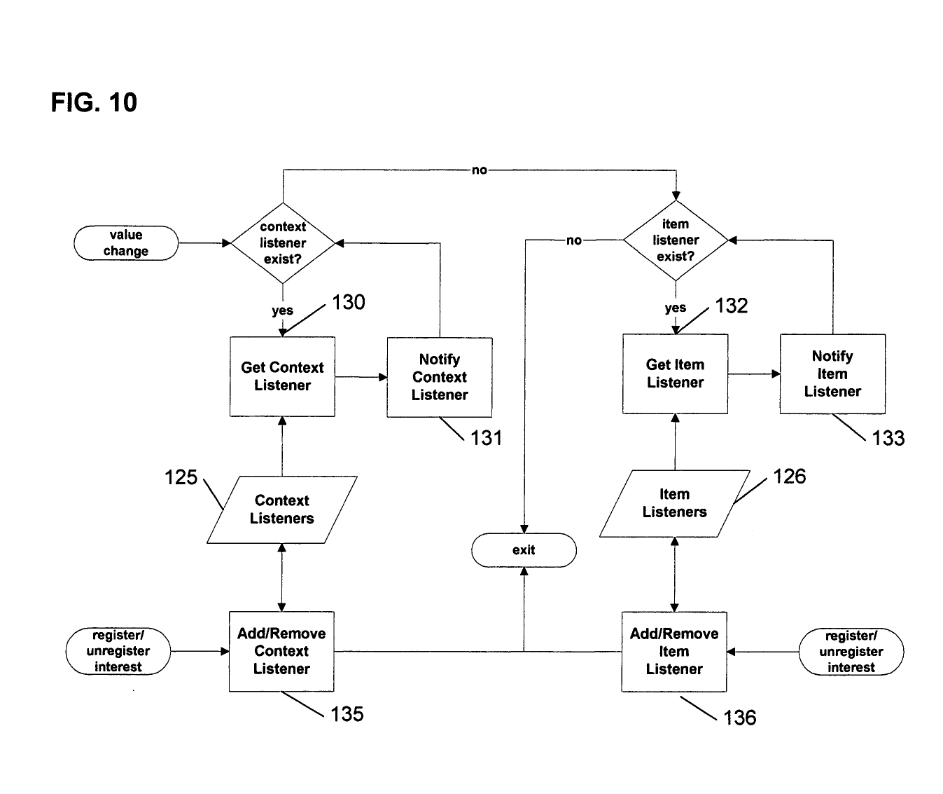

FIG. 10 illustrates a method associated with event notification of Agent Context change events. Event listeners are objects that have an interest in changes to either any entry in a context 125 or in a specific entry 126. These object implement a application programming interface the allows the event notification system to call the listener object whenever the events occur. By using this construct, the notification method can notify each of a set 130 of Context Listeners of the change 131 when it occurs. Similarly, for the specific item changed, each of a set 132 of Item Listeners is notified of the change 133.

FIG. 10 shows additional methods for the registration (adding a listener object) to a list of listeners and removing the registration (removing a listener object) for both the set of Context Listeners 135 and set of Item Listeners 136.

The users of this invention may also wish to monitor platform activities other than just context changes. This invention thus provide methods that are identical to that show in FIG. 10 for registration and notification of such actions as task executions, rule additions/deletions and message receipt/transmission.

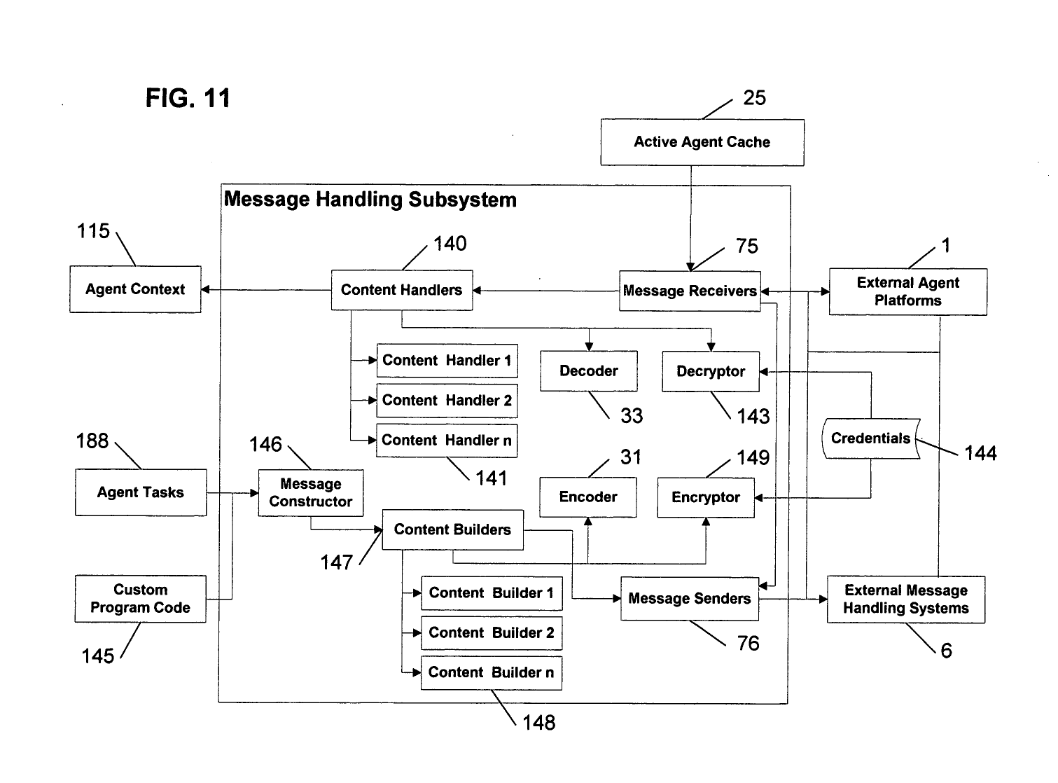

FIG. 11 presents components associated with the Message Handling Subsystem. Incoming messages are received by transport protocol-specific Message Receivers 75 (also see FIG. 6). Message Receivers will check to see if the address associated with the incoming message refers to a local agent 25 (also see FIG. 2). It then hands over the message to the appropriate Content Handler 140. There may be multiple handlers 141 should the platform support multiple message content types. The Content Handler insures that the message in authenticated and decrypted 143, decoded 33 (also see FIG. 2) and then parsed for the purpose of extracting data used to update the Agent Context 115 (also see FIG. 9). Depending upon the implementation of the specific Message Receiver, incoming messages may be queued and persisted for efficiency and reliability purposes. The platform's configuration determines what content handlers are available.

Agent Tasks 188, (also see FIG. 15) or customized program code 145 may initiate requests to send messages. A Message Constructor 166 service will select the appropriate Content Builder 147 from one or more available builders 131. The Content Builder then structures the message appropriately, performs any necessary encoding 31 (also see FIG. 2) and encryption 149 and then hands the message over to the appropriate Message Sender 76 for transmission. The messages “send to” address will always contain within it a protocol designation used to select the appropriate Message Sender. The specific content builders installed are determined by configuration parameters.

The security-related Encyptor 143 and Decryptor 149 components may utilize a stored set of Security Credentials 144 depending upon the method used. Possible credentials include passwords, certificates and public/private encryption keys. A configuration method determines the specific encryption and validation methods supported by the platform.

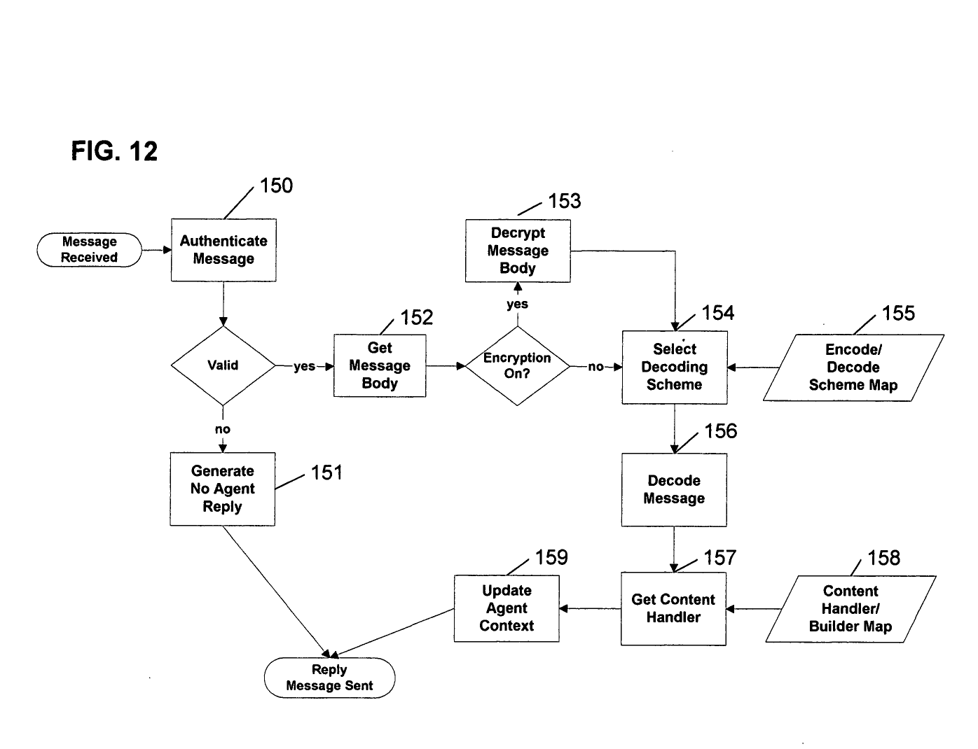

FIG. 12 illustrates the method for receiving messages. Messages in the present inventions contain an envelope and body. The envelope includes sender and receiver addresses and any credentials used to authenticate the sender, decode the message and decrypt the message. This method initially authenticates 150 the incoming message determining if its receiver address specifies a valid agent and if its has valid credentials. If it does not find the agent it transmits an “agent not found” reply 141. This method also checks to see if the agent is a forwarding agent in which case it immediately forwards the message (not show in figure) to the platform to which the agent moved.

This method then gets the message body 152, use appropriate decryption object to convert the body into a readable form 153. It then selects a decoder object 155 form a map containing all available decoders 155, an constructs an object represent the message body 156. Included in the body is a parameter indicating what content handler the system should use to interpret the message body. This method uses this information to get the appropriate content handler 157 from a map of content handlers 158 available to the system. The content handler 159 can then decode the message, which in many cases will result the eventual transmission of a reply message.

Reply messages typically result from agent rules interpreting the incoming messages, although some content handlers may for certain types of messages generate direct replies.

The present invention uses a method nearly identical to the one illustrated in FIG. 7 for configuring services at to generate the Encode/Decode Scheme Map 155 and the Content Handler/Builder Map 158 used in this method for receiving messages.

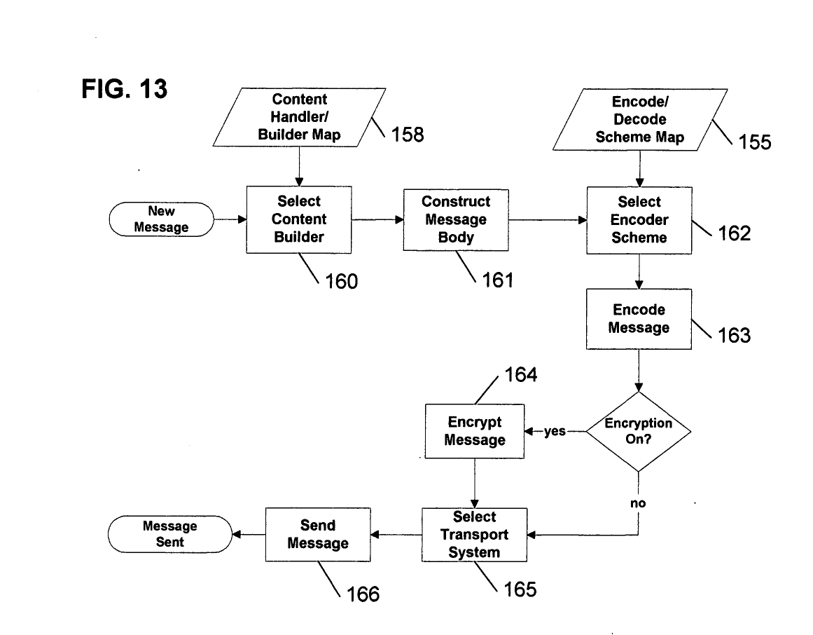

FIG. 13 illustrates the method for sending messages. New messages must specify the content builder or use default one, which this method selects 160 from the Message Handler/Generator map 155. It then uses the Content Builder to create the message body 161. Next this method selects an encoding scheme 162 using it to encode (serialize) the message body 163. Also, if encryption is indicated this method uses the appropriate encryption object 164 to encrypt the message body. Finally, this method uses the receiver agent address to determine what transport service 165 to use for sending the message 166.

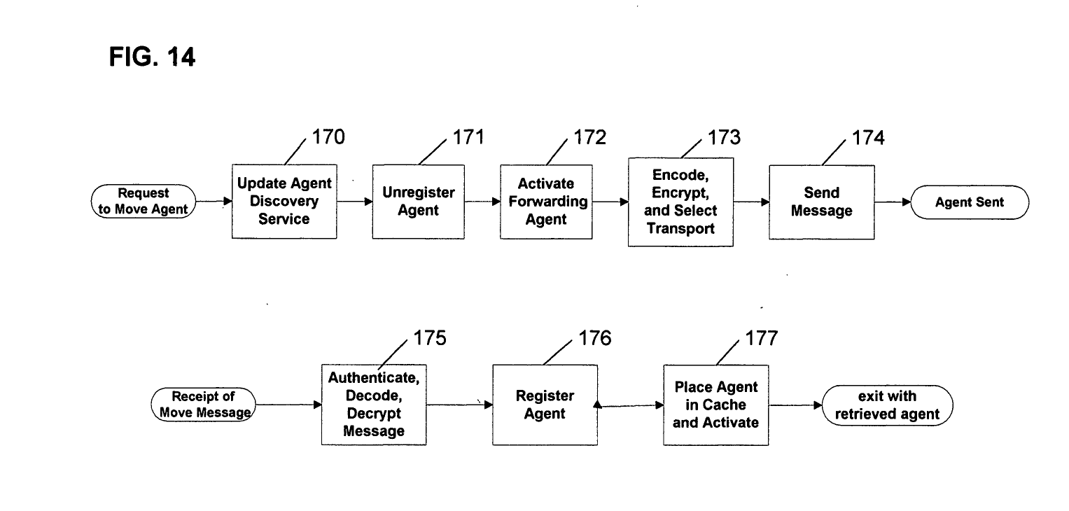

FIG. 14 illustrates the method for moving an agent from one platform to another. The request to move an agent require updating the agent's discovery services to indicate the new address for the agent 170 and subsequently removing the agent's registration within the event handling system 171 (see method of FIG. 10). This latter step involves removing all the triggers for all agent rules as listeners for context item change events.

This method then replaces the agent with a forwarding agent 172. This step handles any time delays that may exist between having messages sent to the agent at the current location and the posing of the new address with the discovery services running on other platforms. The agent deactivation process (see method of FIG. 5) will eventually remove any references to this agent from the system.

This method then performs the encoding, encryption and transport selection activities 173 described in the method for sending message method (FIG. 13) use the agent itself and the message body, and it then actually sends the message 174.

FIG. 14 also presents a method for receiving the transported agent. This method uses the same process of authentication, decoding, and decrypting the message 175 as described in the method for receiving messages (FIG. 12).

This method also registers the agent 176 and adds it to the platform's agent cache 177. Registration involves adding all the triggers for all the rules to the listener list for context item change events.

FIG. 15 presents components associated with the Task Execution and Inference Subsystem. The key component to this system is the Interpreter 180. This invention uses an application programmer's interface to represent the Interpreter, enabling agents to select from a plurality of Interpreter implementations 181. Each agent can only have one instance of an Interpreter, but the Interpreter used may vary from agent to agent. Each Interpreter contains a agent context that provide a method to map names to a set of standard values maintained by the platform. These standard values include integer, floating point, long integer, long floating point, boolean and string values. Individual Interpreter implementations may optionally extend the agent context by providing extensions 182 that define additional data structures or objects that this system can incorporate into the agent context.

All values, maintained by the agent context and its extensions, extend an object called Value Reference 185. This makes it easier for methods associated with the Task Execution and Inference system to reference and manipulate values in forming complex logical and mathematical expressions.

The Interpreter also references rules 183 that relate values or changes in values to the execution of agent tasks. Rules include one or more Triggers 186, an optional logical condition or predicate 187, and one or more Tasks 188. This invention defers the definition of the triggering mechanism to specific, Interpreter-defined implementations 189. Each Interpreter must define its own triggering mechanism. All triggers, however, are agent context listeners, thus implement the application programmers interface specified by the event subsystem (see discussion of method in FIG. 10).

Rules also may contain variables 184 that point to selected values from the agent's context. These variables are useful in evaluating Predicates and providing parameter values to Tasks and there associated Service Adapters 190.

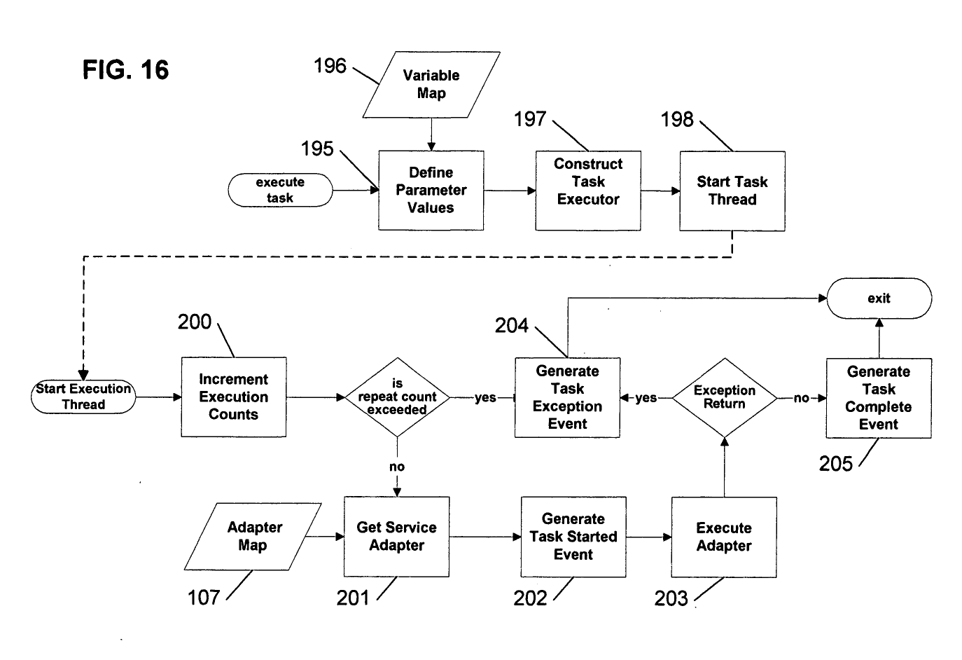

Since methods to process rules depend upon the specific Interpreter embodiment, discussion is deferred until presentation the Interpreter included within this disclosure. FIG. 16 presents a method for processing Task objects.

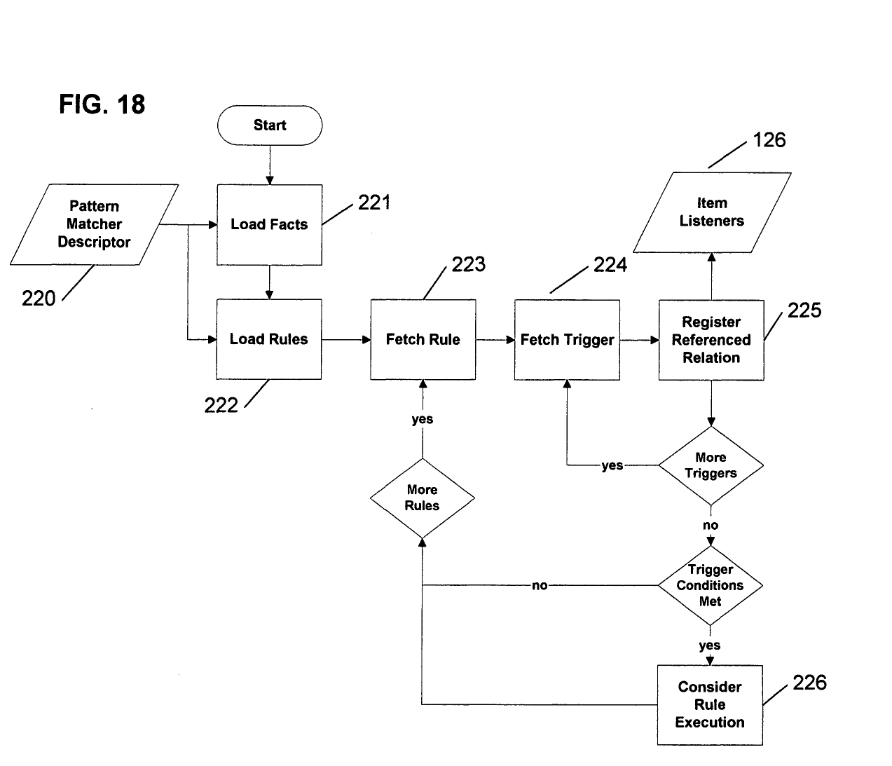

Agent Tasks, which minimally contain a trigger attribute, a set of Boolean Conditions and a reference to service (with parameter values if needed), may also have a arbitrary set of named values associated with it. These values are typically used to provide information to the Inference Engine. Certain Inference Engine implementations may require the existence of named parameter values, which can be set to a default value and optionally changed by the user. This document provides more information on data associated with the Agent Tasks later in the discussion of user interface components (see FIG. 18).

FIG. 16 illustrates the method used by Tasks and their associated Service Adapters to execute platform services. Tasks are defined by the user defining who defines the rules and consist of a reference to a specific Service Adapter and a list of parameters associated with the Service Adapter. Each parameter name may reference a constant value (as defined by extensions of the Value Reference 185 in FIG. 15) or the name of a variable (see 184 in FIG. 15) that is associated with the rule.

This task execution method then begins by defining the parameter for the service 195, extracting values from the rule's variables 196 where specified.

This method then constructs a task executor 197 object capable of running in its own thread of execution and starts this thread. The present invention threads each Task so that the system does not have to wait for a long running service to complete prior to executing other tasks.

The Task Executor optionally maintains a count of active tasks 200 and can abort the task and generate an exception 204 when the number of task execution exceed this count. Some Interpreters may use this feature to prevent cycling of task executions.

This method then retrieves the service adapter 201 from the adapter map 107 created at system startup when the service management system configures its services (see method described in FIG. 7).

This method generates internal events to report the start 202, and successful 205 or unsuccessful 208 completion of task executions. This event reporting provide a method for tracking service execution activity using GUI components and/or loggers. Some Interpreter implementation may also monitor these events.

Service adapters, since they are customized modules of computer code, can vary from on implementation to another. Generally, when executed 203, a service adapter will take parameter values provided by the task, execute a service call, and use any returned values to update the agent context.

In some cases, the Service Factory that constructs the service adapter will execute the adapter within a long-running, separate execution thread. Agents would typically not execute these adapters but they will routinely request data from an installed service and post it to one or more shared agent contexts. Thus data changes will be automatically provided to any agent registering an interest in the shared context. This invention also supports methods in which services directly post data events to the platform either as context change events or as agent messages.

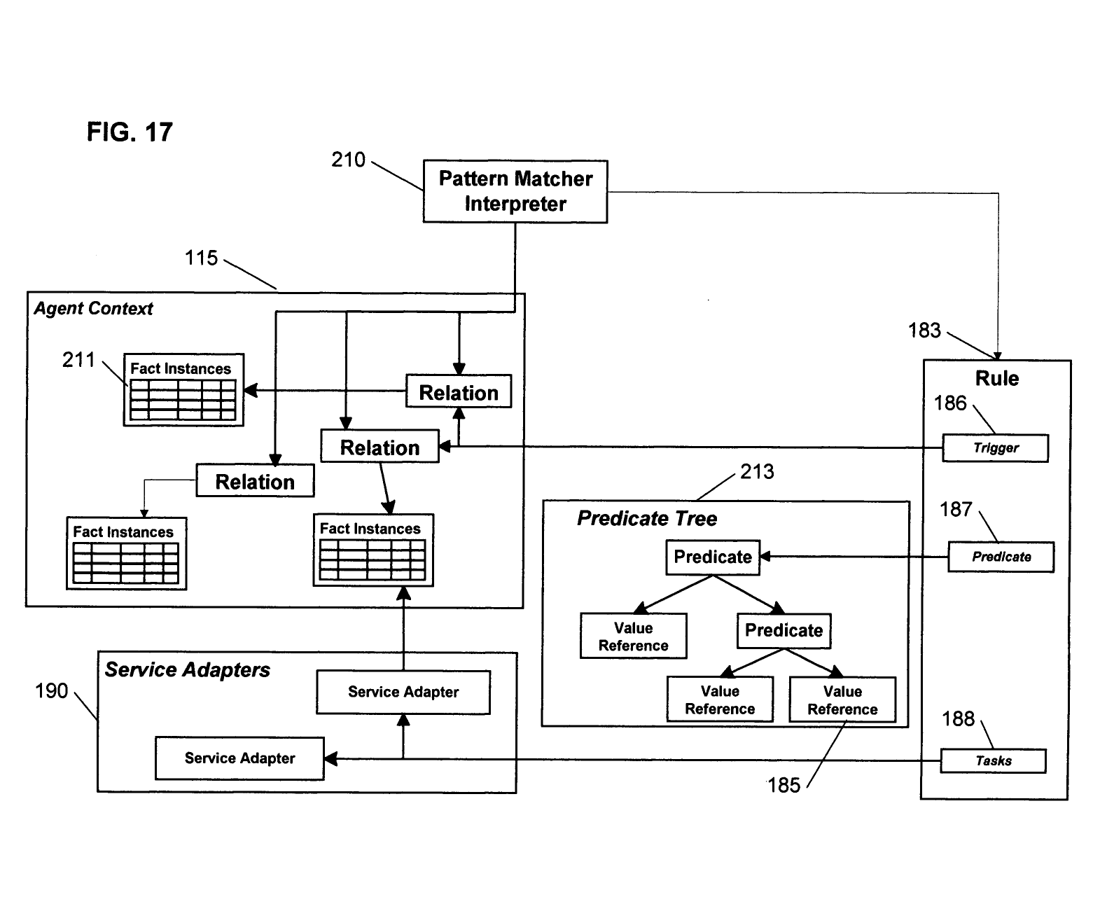

FIG. 17 presents an embodiment of the Interpreter component of the present invention that reacts to patterns within its context data to trigger rules and provide data to rule variables. This system component, called Pattern Matcher 210, extends the Agent Context data types to include groupings of related data called “tuples.” A set of tuples comprise a group of Fact Instances 211. Methods that result in changes to these data structure involve adding a tuple or “asserting a fact” or removing a tuple or “retracting a fact.” The Pattern Matcher uses changes in this tuple data to determine when to consider or trigger a rule 183.

Also, the Pattern Matcher uses, the term “relation” 212 refers to a set of similarly named and structured Fact Instances. A relation definition may define a data pattern that allows selection of a subset of tuple instances for the purpose of triggering a rule. For instance, the relation, Person(?name, ?age, ?sex) defines a tuple containing three values. The pattern, Person(?name, 25, male), specifies the selection of all “Person” tuples for males of age 25.

Triggers within the Pattern Matcher are relations that contain variables that reference the set of tuple values that happen to match the relation's pattern. This system then considers the rule for execution if (1) at least one fact assertion and retraction occurs and (2) all the relations used to trigger the rule have matching patterns.

When the rule is considered for execution, the system evaluates the optional Precondition Predicate 187 using variable values derived from the matched pattern. This inference system requires that any existing precondition evaluate to true prior to task execution. If none exists then the system always executes the tasks 188 whenever the data satisfies triggering condition as stated in the previous paragraph.

Predicates involve the logical comparison of two or more Predicates or Value References 185. This enables the construction of arbitrarily complex logical relationships that can be expressed in the form of a Predicate Tree 213.

Task execution uses services adapters and the method described in FIG. 16.

FIG. 18 provides a method for activating the Pattern Matcher at the time the agent is constructed or activated (see 45 in FIG. 3 and FIG. 4). The method uses information from a Pattern Matcher Interpreter Descriptor 220 (a part of the agent's template) to load facts 221 into the agent's context and rules 221 into the interpreter component of the agent. This method uses descriptor objects that are part of the interpreter descriptor to represent and construct facts and rules as discussed in the method for agent construction (FIG. 3).

The process of loading facts defines relation entries for the fact. If two or more facts reference the same relation they are grouped together as separate fact instances for the same relation. Triggers in this system express interest in changes to the relation in the form of additions and removals of fact instances. Once asserted, this system does not allow changes to individual data components of a fact instance.

This method then iterates through each rule 223 and each trigger 224. For the trigger, this method registers itself with a Relation within the agent. It there are already fact instances defining the Relation, it uses the existing relation and adds itself as an item listener 126. Otherwise, this methods creates a new Relation that has no fact instances, for which trigger will listen for new fact assertions or fact instance additions.

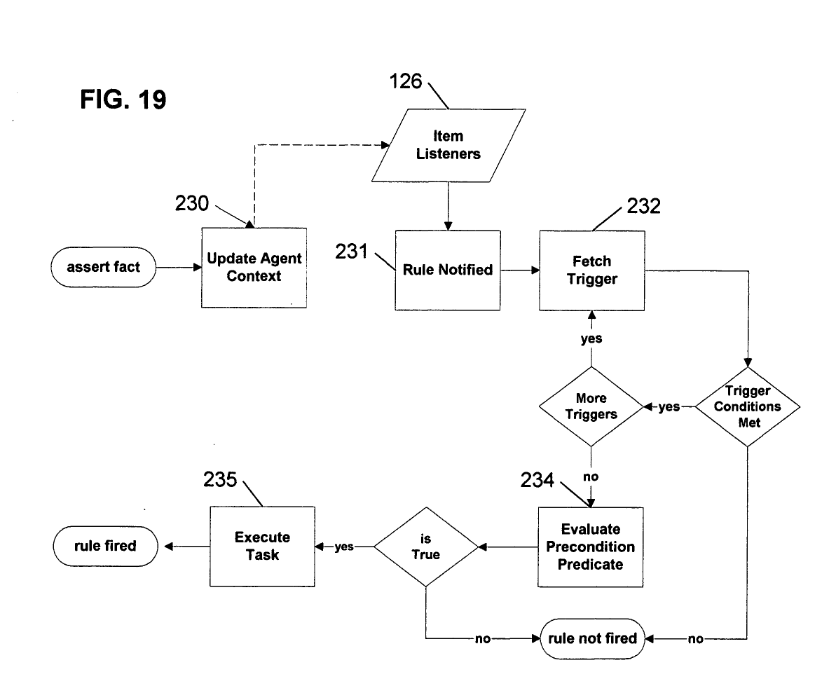

After this method processes all the triggers, then it checks them for a match 226. Matches occur when there is at least one fact instance within the Relation's tuple set that meet the criteria established by the Relation's pattern. If this occurs then the rule is considered for execution 226. The method associated with asserting a fact (see FIG. 19) further explains the rule execution process.

FIG. 19 presents a method that describes the consideration and possible execution of rules upon assertion of a new fact. An internal platform service provides that allows service adapters, message content handlers and other services managed by the platform to add facts to an agent's context 230. This immediately invokes the event notification method (see FIG. 10), that results in the notification of all the registered rules of the change 231.

This method then iterates over all triggering relations 232 to determine if a trigger's pattern matches at least one of the corresponding fact instances. If any one does not, this method is terminated without the rule firing. If all match, then this method evaluates the logical precondition 234. A false predicate evaluation also results in exiting the method without the rule firing. Otherwise, this method initiates the task execution process (see FIG. 16) for all tasks specified by the rule. If there is no precondition specified, this method will automatically execute the tasks upon matching all relations.

Relations definitions within rules, contain variable references (denoted by a ?name within the pattern specification). These variables provide value references used within predicates and tasks. Often more than one tuple will provide values for these variables. This invention supports two methods for handling this situation. The normal method is to iterate over all permutations of the possible variable values that satisfy the relation constraint. Each permutation then results in a precondition evaluation and possible task execution. Alternatively, the rule developer may specify that a variable can assume multiple values. In this latter case, this method provides an array of values to the predicates and tasks.

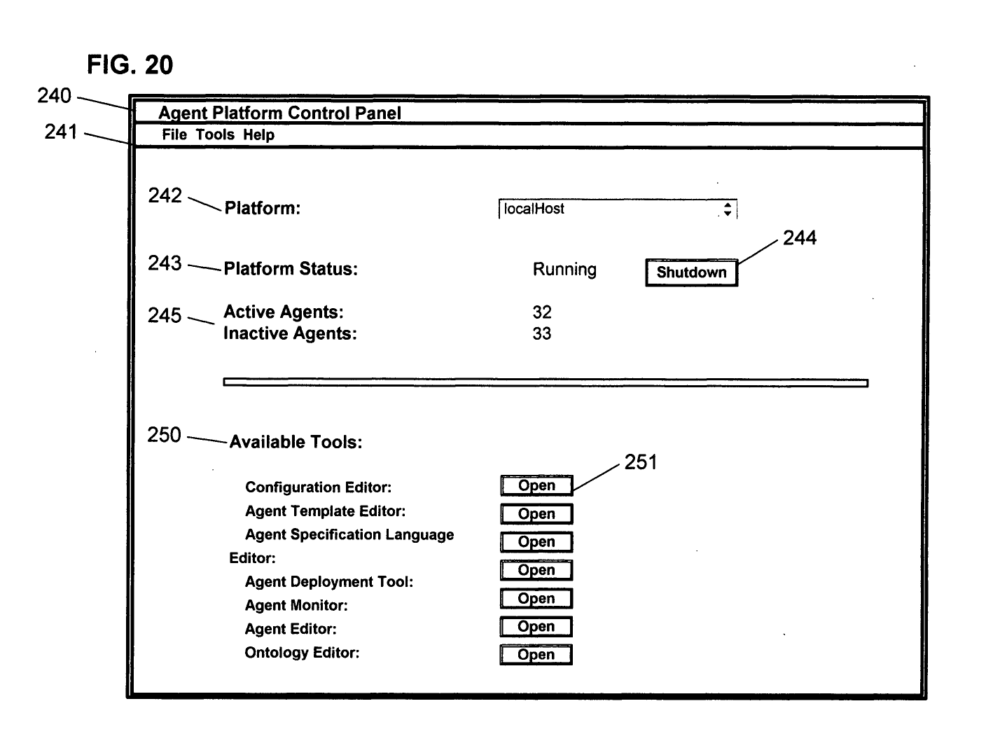

FIG. 20 and all subsequent drawings describe user interface components used by an embodiment of the present invention. The components represent those commonly available on most computer system that support a Graphical User Interface (GUI). They include component containers such as windows and panes, including a special type of pane called “tabbed pane”. A “tabbed pane” (see 189 in FIG. 14 for example) contains multiple sub-panels, each labeled by a tab that extends out from the individual pane. The user can view only one sub-pane at a time but is able to see all the labeled tabs. The user selects sub-panes for display by using a pointing device (such as a mouse) or a keystroke sequence to move a display cursor over the tab and then pressing a pointing device button or key.

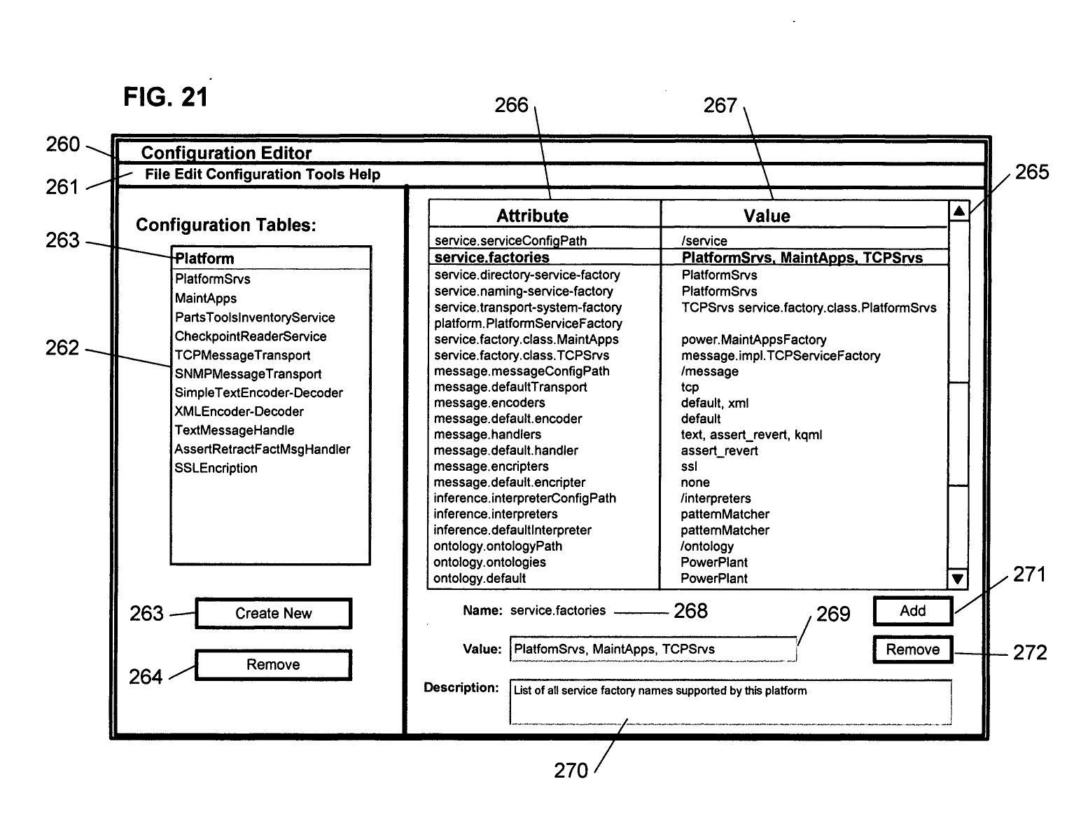

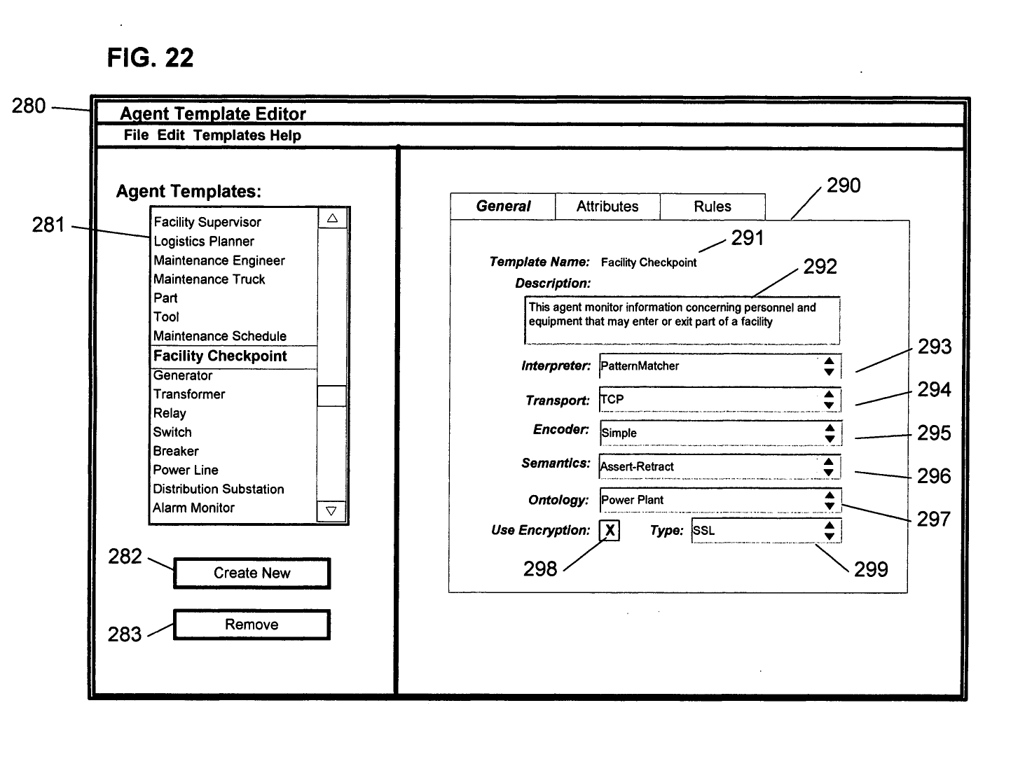

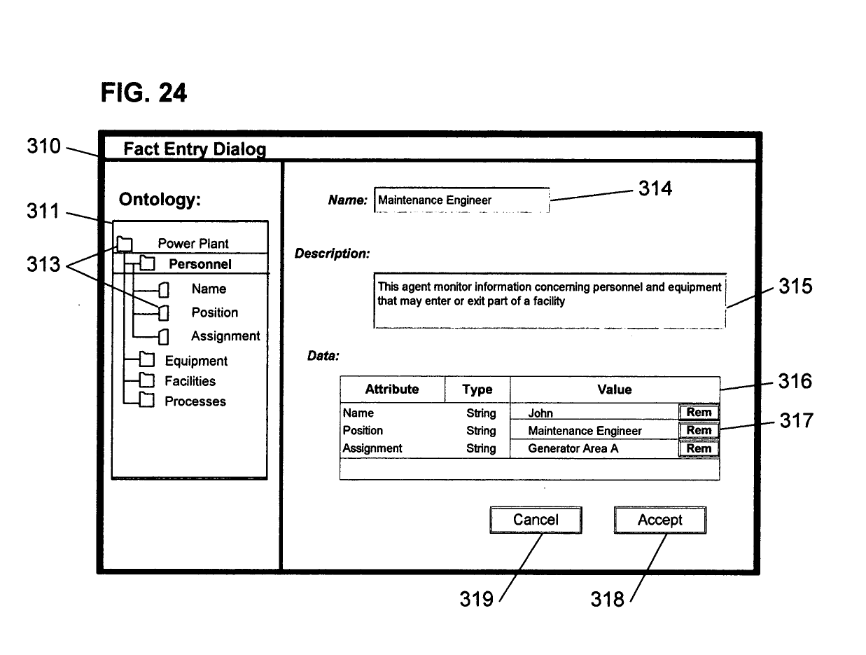

Other commonly used components include (1) buttons (see 244 in FIG. 20 for an example), which enables the user to invoke code segments called actions by using a pointing device or keystroke sequence, (2) list boxes (see 162 in FIG. 21), which display a list of items allowing the user to also select individual items with a pointing device or keystroke sequence, (3) combo boxes (see 242 in FIG. 20), which include a list of items, displayed only when a arrow icon is selected, from which the user uses a pointing device or keystroke sequence to select a field value, (4) text fields (see 269 in FIG. 21) for direct entry of textual information, (6) check boxes (see 297 in FIG. 22)), which also allows the user to select or deselect an individual item with a pointing device or keystroke sequence, (7) tables (see 316 in FIG. 24), which displays a list of multiple items arranged in tabular format, rows of which can be selected with pointing device or keystroke sequence, and (8) a hierarchical or tree list (see 311 in FIG. 24), which display items arranged in a tree format in which the users can expand (show children) or compress (not show children) or simply select nodes of the tree using pointing devices or keystroke sequence.

Most GUI components initiate actions, which are segments of code executed as a result of a user's interaction with certain GUI components. The term, application, refers to the software used to create and control this GUI. Some windows, called modal windows, do not allow access to other window when displayed. This discussion typically uses the term “Dialog Window” in labeling modal windows, which typically provide detailed information concerning items in the parent window.

FIG. 20 illustrates the GUI that, in one embodiment of this invention, is displayed initially upon invoking the GUI system. The object of the GUI is to allow a user to view platform data, startup or shutdown a platform and access other GUI components.

This GUI comprises a tide bar at the top of the window 240 with the text, “Agent Platform Control Panel” and a menu bar 241 containing a list of actions the user can invoke from this window.

The menu bar provides lists of sub-menus, each referencing a subset of actions. The user accesses a sub-menu by using a pointing device or keystroke sequence to position a cursor over a menu item and selecting it with a button on the pointing device or a keystroke. When the user selects a sub-menu, a list of sub-menu options is displayed and the user then selects specific options in the sub-menu. In another embodiment of this GUI, the user can invoke actions by using a tool bar (not shown in diagram) containing button components labeled with icons. The user can also invoke an action by selecting a button and certain other components displayed on display panes or dialog windows appearing within the various GUI components.

The File sub-menu contains an actions that allows the user to attach to a running platform, either on the local or a remote machine. By attaching to a platform, the GUI does not only get access to the platform data but registers on interest in system events signaling changes in data maintained within the platform. This allows the GUI to dynamically change to reflect changes occurring within an actively executing agent platform. Also, the user may alternatively use the file menu to load information from a stored, inactive agent platform configuration, to create a new platform configuration and to save a configuration. The file menu also provides an exit action.

The Edit sub-menu allows for copying, cutting and pasting of information from and to the fields displayed in the interface and usually only appears on windows that the contain text or other components, which can in part or whole be copy or moved. The GUI in FIG. 20 does not utilize this sub-menu. The help sub-menu also appears on most menu bars and allows user access to information on how to use the system.

The Tools sub-menu provides user access to the various windows available on the system. In addition, specific windows will contain specialized sub-menus providing access to actions available with the context of the individual GUI.

This GUI window contains a combo-box 242 for selecting the specific agent platform with which the GUI interacts. The present invention includes a service allowing remote access to agent platforms.

This GUI window contains displays for showing whether or not the platform is in a “running” state 242 and provides summary data on the platform 245. A shutdown/startup button 244 allows the user to bring the system up or down. This initiates the agent activation method (see FIG. 4) on startup and the deactivation method (see FIG. 5) on shutdown.

The remainder of GUI illustrated allows the user to access the other GUI components 250 using a series of buttons to select each one. The tools sub-menu provides an alternative methods to access these components. Details for these items are presented and discussed in the following paragraphs of this disclosure.

FIG. 21 provides a GUI component for maintaining platform configuration data as discussed in Appendix A. This window includes a title bar with the text “Configuration Editor.” The menu-bar 261 that includes a Configuration sub-menu that provides access to actions that the user can use to create a new configuration, remove a configuration, and add and remove configuration elements.

A list box 263 allows the user to select a specific configuration table or file. This figure shows the selection of the “platform” table 263, whose data is displayed in a table 265 containing columns for configuration attributes 266 and values 267.

When the user selects a row in the table the GUI displays an attribute name 268, value 269 and optional description 270. The user can then change these values or present the add button 171 to create a new entry. The “add button” action generates a dialog into which the user enters the name for the new attribute. The user can then modify value and description for this new attribute with existing ones. The remove button 272 allows the user to delete an attribute entry.

FIG. 22 presents the GUI for creating and modifying user template data. This window comprises a title bar labeled “Agent Template Editor” 280 and a list of templates available to the platform. This list illustrates some possible agents for a simplified agent application as described in Appendix B. The user can add templates by selecting the add button 282, at which time a dialog window allows entry of the template name and the system creates an empty template that is added to the list. The remove button deletes a template from those available.

When the user selects an item in the list the GUI displays the information concerning the template within at tabbed panel 290. FIG. 22 only show items within the “General” tab, which include the template parameters shown in the figure. The other tabs, Attributes and Rules, display data discussed is other figures.

The general panel includes the display of the template name 291 and a GUI field that enable the user to change template data. These include a field for entering a description of the template 282, combo boxes that allow the user to select from the configured options available to individual agents. These options includes the Interpreter used 283, the default transport used by the agent to send messages 294, the encoder used 295, the content generator used for represent the message semantics 296, the ontology used by the agent 297, and the type of encryption 299 used if any. There is also a check box 298 used to turn off encryption.

The data displayed in FIG. 22 illustrates the selection of data concerning a checkpoint agent whose responsibility is checking the credentials of people and materials entering a power generation facility. This agent uses the pattern matcher interpreter. This discussion will show that some GIU displays handle data specifically for this interpreter type. This agent also uses a specific ontology, which will affect information displayed within some GUI components.

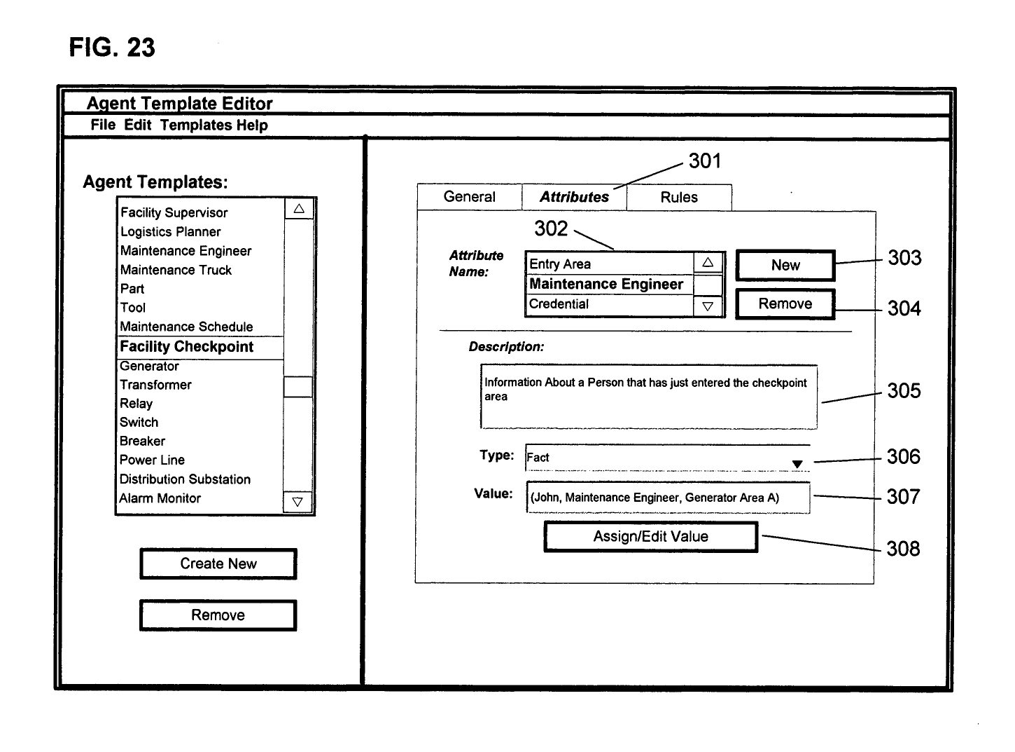

FIG. 23 shows the Template Editor tab panel for displaying 301 and editing attributes associated with an agent. These attributes are values loaded within the agent context upon deployment of the agent. These are initial values, which may change as the agents receives messages and executes tasks.

The “attributes” panel contains a list box 302 providing names for each attribute. The “new button” 303 generates a dialog for entry of the attribute name, which the system adds to the list. The remove button 304 enables deletion of the selected attribute.

After selection of an attribute from the list, the user can modify the description 305, and selects the attribute type 306 from a list of types available, including extended types that a specific interpreter may require.

This panel also contains a field 307 for the initial value assigned to an attribute. Depending upon the value of the type selection, the user may modify this initial value directly or request display of a dialog for specifying values 308. Often interpreter implementations will define complex types that may require a specialized dialog for specification and entry.

In the illustrative data within FIG. 23, the user selects a Fact type, which requires specification a tuple structure. Thus FIG. 24 shows a dialog for entering the fields within the tuple structure. This window is a modal dialog window, labeled “Fact Entry Dialog” 310.

This dialog includes a tree list 311 representing the hierarchical structure of the ontology. With in this tree there are group names and attribute names, each representing by a differing icon 313 within the list. Groups may contain mix of attributes and other groups. Attributes cannot contain any child tree nodes.

When the user selects a node in the tree information, the system displays information concerning the ontology entry. This includes name 314, description 317 and a table listing 316 the child attributes or groups.

The use may specify values for items extracted form the ontology. For instance, within this illustration, the user selects a personnel entry, renames the fact specific to “Maintenance Engineer”, customizes the distribution and enters the data, (John, Maintenance Engineer, and Generator Area A), for the fields.

In some cases the fact data may not include all the fields. A button 317, appearing next to each field provides the option of removing the attribute. Also, items displayed within a group may contain other groups, in which case another dialog nearly identical to this one would appear. This second dialog would not contain the tree list 311, since the prior dialog already established the name for the subgroup. The end result is the nesting of tuple data to an arbitrary depth.

Also, within the dialog of FIG. 24, an “accept” button 318 results in the actual construction of the tuple or fact instance and the returning of this object to the initiating window. The “cancel” button aborts the specification.

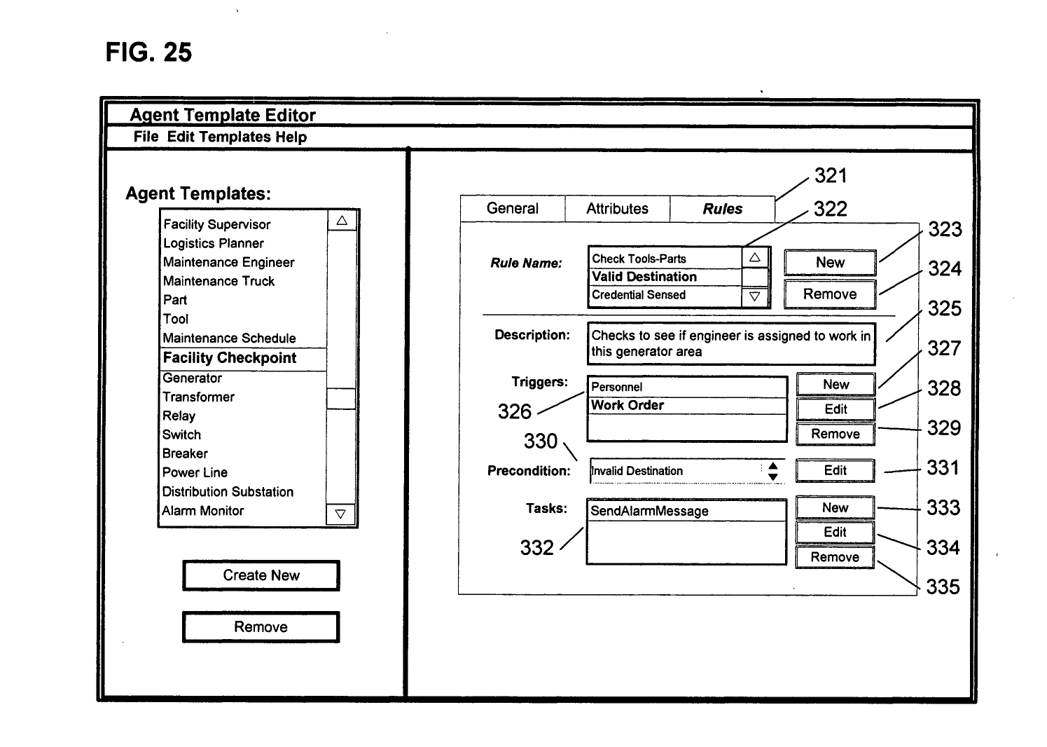

FIG. 25 shows the Template Editor tab panel 321 for displaying and editing rules associated with an agent. The “rules” panel contains a list box 322 providing names for each rule. The “new button” 323 generates a dialog for entry of the rule name, which the system adds to the list. The remove button 324 enables deletion of the selected attribute.

After selection of a rule from the list, the user can modify the description 325, and a series of buttons to specify or edit triggers, the precondition, and tasks.

The rules panel includes a list box 326 that displays all defining triggers for the rule. The “new” button 327 opens a dialog for creating a new trigger and the “edit” button 328 opens a similar dialog for changing a trigger specification. These dialogs depend upon the selected interpreter, since individual interpreters define their own triggers. The remove button 329 allows deletion of the selected trigger.

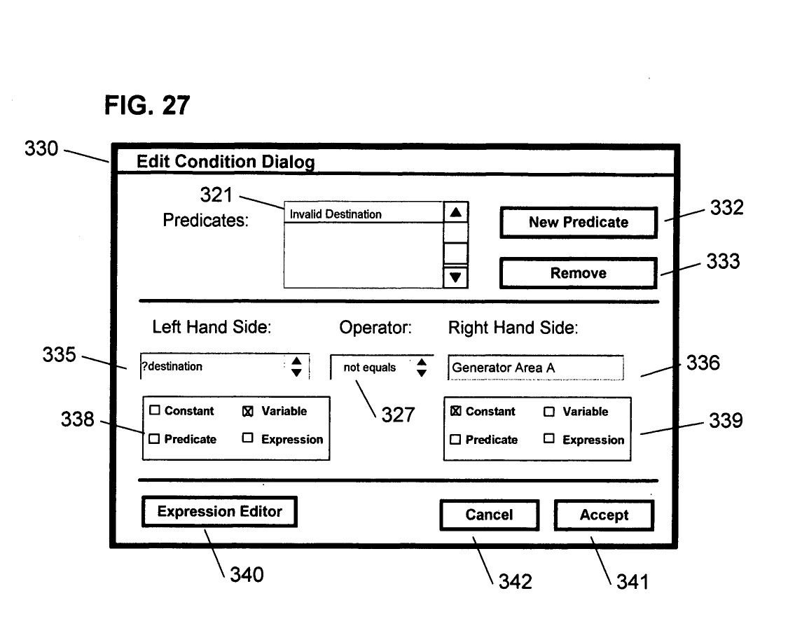

The precondition combo box 330 allows the user to select from one of a list predicate (if any) defined for the rule. The “edit” button 331 associated with the precondition opens a predicate editor dialog (see FIG. 27) allowing the user to define one or more predicates composing the predicate tree for this condition.

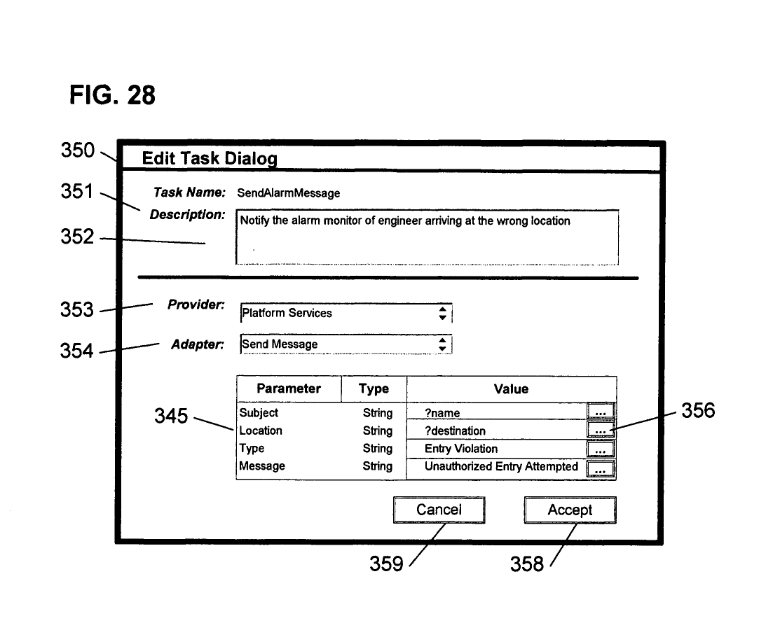

The rules panel includes a list box 332 that displays all defining tasks for the rule. The “new” button 327 opens a dialog for creating a new task and the “edit” button 328 opens a similar dialog for changing a task specification (see FIG. 28). The remove button 329 allows deletion of the selected task.

The data illustrated in FIG. 25 shows the definition of a rule checking to see if a person entering a facility with the power plant is authorized for entry. Data on the person (obtained from another rule that checks credentials) and on the work order triggers this rule. A logical check determining that a person is not valid results in a task executing a message to an alarm monitor agent.

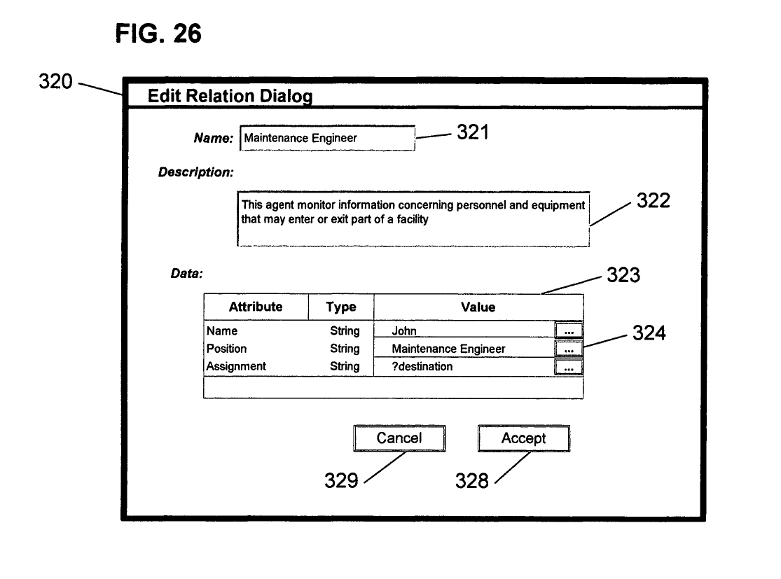

FIG. 26 show the dialog, tided “Edit Relation Dialog”, 320 for specifying a relation entry. This relation entry is the trigger used by the Pattern Matcher Interpreter.

This dialog includes fields for entering the name 321 and description of the relation 322 and a table defining its data pattern 323.

The entry of the data for this table is the same as with fact data (see FIG. 24), with the addition that field may contain variable definition. Selection of the button associated with each entry 324 will switch the entry field to a combo box containing a list of available variables. User may also enter new variable specification by typing in a name proceed by a question mark. A variable name followed by a set of squared brackets ([ ]) indicates that the variable can match to multiple values.

For specifying new relations this dialog also includes the display of the ontology tree so that the GUI can enforce the appropriate data type definitions.

The data illustrated within this dialog defines a pattern representing data concerning a maintenance engineer. With the pattern the assigned destination is a variable.

Also, within the dialog of FIG. 26, an “accept” button 318 results in the actual construction of the relation definition and the returning of this object to the initiating window. The “cancel” button 319 aborts the specification.

FIG. 27 show the dialog, titled “Edit Condition Dialog”, 330 for specifying and editing a set of predicates. A list box 321 displays the available predicates. The “new” button 332 opens a dialog for specify the new predicate name. The “remove” button deletes the selected predicate.

The user uses a left-hand side field 335, operator combo box 327, and a right-hand side field 336 to enter the predicate's data. The contents of the left and right hand sides fields may be constant values, variables, arithmetic expressions and other predicates. The group of check boxes allow specification of these values for both the right hand side 338 and the left hand side 339.

For all types except constants a combo box appears in the entry field allow selections of the available item of the specified type. To define expression the expression editor button produces a display nearly identical to the dialog for the condition editor. The only differences are having the operator choice produce a set of arithmetic operations and not allowing the user to make predicate selections.

The data illustrated within this dialog defines an expression that determines if a maintenance engineer arrived at the proper destination. The logical conditions compares the destination variable with a constant values indicating the name of the local facility.

Also, within the dialog of FIG. 27, the “accept” button 341 results in the actual construction of the predicates specified in the current session and the updating of the rule's list of allowable predicates. The “cancel” button 342 aborts the specification.

FIG. 28 show the dialog, titled “Edit Task Dialog”, 360 for specifying an agent task. This dialog includes fields for entering the name 351 and description of the Task.

The user then selects the provider of the adapter using a combo box listing all configured service providers. Once selected, the adapter combo box 354 now includes a list of all adapters provided by the service provider. The user selected the desired adapter and the parameter table 345 is filled with the parameter definitions for the adapter.

The user then enters values or variables that the task execution method (see FIG. 15) uses to provide parameter values to the service it calls. The buttons next to each entry field switches the field to a combo box enabling users to select a variable for a list of available ones.

The data illustrated within this dialog defines the task of sending a message to an alarm monitor agent. Since messaging services are provided by the platform, the user selects the platform services provider.

Also, within the dialog of FIG. 26, an “accept” button 318 results in the actual construction of the relation definition and the returning of this object to the initiating window. The “cancel” button 319 aborts the specification.

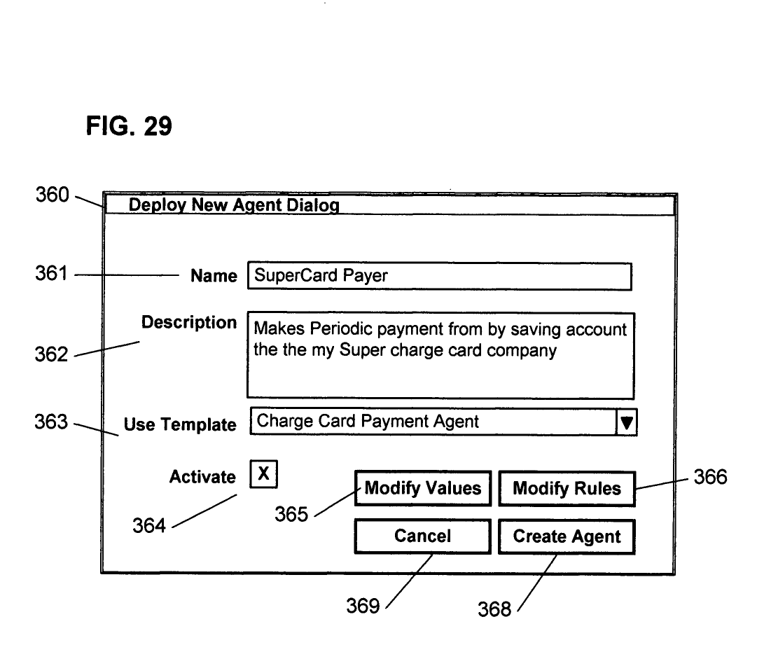

Once a template is defined, another GUI component allows the user to request deployment of the agent to the platform. FIG. 29 shows this component, which is a dialog labeled “Deploy New Agent” 350.

This dialog enables the user to specify a descriptive name 361 (a globally unique name is assigned automatically by the naming service) and a longer description 362 for the agent.

The user then selects the agent's template from a list of ones defined for the platform and uses a check box 364 to determine whether or not the system should activate the agent immediately. If not activated the agent resides within the persistent store until receipt of message directed to the agent.

The modify values 365 and the modify rules 366 allows the user to modify the template prior to deployment. These modifications only affect the deployed agent and not the stored template. Actions associated with these buttons open up a dialog containing GUI components identical to those on the attributes (see FIG. 23) and rules (see FIG. 25) panels of the Template Editor.

The “create” agent button 368 instructs the agent platform to use the template to construct and agent using the method outlined in FIG. 3. The “cancel” button 369 terminates the deployment activity.

FIG. 30 presents a GUI component for monitoring platform activities. This component is an window titled, “Agent Platform Monitor” 370 and it includes a view sub-menu in its menu bar. The display varies depending upon the type of platform event that the user wishes to examine. View may exist for such events as agent context changes, task executions, agent messaging and exception reports. The user may also limit the view to a specific agent or for context items a specific context entry.

FIG. 30 illustrates a view that monitors task executions for all agents on the platform. A table 271 displays each event on a separate line. For the case of task event this view displays the time of the event, the agent generating the task, the service adapter used, the event status (start, stop and abort) and a message indicating the exception generated by an aborted task. This GUI component registers itself as being interested in task execution events and then displays each event as received.

A pause/resume button 373 allows turning on and off the event viewing process. The exit button removes the GUI's registration and closes the window.

This present invention also provides a method of using a computer language to specify agent templates. A GUI interface or additional panel to the Template editor can provide a text editor that enables the user to enter the template definition in a language format. Appendix C provides specification for one embodiment of such a language.

The present invention also allows changes to an agent's rules and context data while the agent is running. This system would use a GUI nearly identical to that described for editing.

1. A computer-based software system, called the agent platform, that provides integrated services for the deployment of intelligent software agents comprising:
A system for creating, storing, retrieving, moving and removing autonomous software modules called intelligent software agents.
An extendible service management subsystem that allows services to be easily added and removed from the platform and enables software agents to automatically access these platform services.
An messaging infrastructure that allows developers to add message handling functionality at three levels, the message transport layer, the data encoding and encryption layer, and the message semantics layer.
An event mechanism, that allows agents to react to changes in their environment. This system provides an Agent Context which developers can extend to support alternative data representation schemes.
Infrastructure for allowing agents to interpret user-defined rules and execute services based upon those rules that involves the incorporation of a software module called an Inference Engine.

2. An embodiment of an inference engine of claim 1 that provides a real-time, rule-based inference system based upon matching data patterns within the agent's context.

3. A method to support the interpretation of rules within the inference engine of claim 1 and the specific embodiment of the same in claim 2.

4. A method that utilizes a software interface called a service adapter, to provide a generic way for system developers to specify how to handle service execution requests and service execution parameters. Agents use this service adapter to execute the platform services specified in claim 1.

5. A method that uses configuration data for selecting, adding and removing services, message transport systems, data encoding/decoding schemes, encryption schemes and software modules called message handlers and generators and any other configurable components to the system specified in claim 1.

6. A system for constructing intelligent agents, which is used by the agent lifecycle subsystem within claim 1 to create and deploy agents using a template mechanism.

7. A method for constructing and deploying agents in the system of claim 1 using the template mechanism of claim 6.

8. A method for using a graphical interface for specifying the templates in claim 6.

9. A method for using a computer language for specifying the templates in claim 6.

10. A method for using a graphical user interfaces for monitoring and configuring activities of the system of claim 1.

11. Methods for storing and recovering agents from persistent storage as needed for use in the system of claim 1.

12. A methods of using the event mechanism of claim 1 to support the graphical user interfaces of claim 10 and support systems for logging system activities.

13. Methods for applying the inference engine of claim 2 to problems involving the maintenance, control of power and distribution systems. This method is applicable to a wide variety of situations including but not limited to tracking of materials through various distribution systems whether they are electric power, chemical, oil and gas distribution systems or rail, ship and motor vehicle systems.
This invention enables interaction between a plurality of organizational units including suppliers of such items as manufactured goods, producers of power from such sources as nuclear, hydro and fossil fuels, and suppliers of maintenance and security services. It also supports the interaction with the suppliers and the distribution organizations such as logistics companies, gas and oil pipeline companies and common carriers. Finally, it supports interactions with the consumers of goods and services including both individuals, commercial and government organizations.
